(19) United States
(12) Patent Application Publication
(10) Pub. No.: US 2026/0261330 A1
(43) Pub. Date: Sep. 3, 2026

(54) NON-TERRESTRIAL NETWORK IMPROVEMENTS

(71) Applicant: QUALCOMM Incorporated, San Diego, CA (US)

(72) Inventors: Francesco GRILLI, La Jolla, CA (US); Alberto RICO ALVARINO, San Diego, CA (US); Udayan BHAWNANI, San Diego, CA (US); Carlos CABRERA MERCADER, Cardiff, CA (US)

(21) Appl. No.: 19/551,240

(22) Filed: Feb. 26, 2026

Related U.S. Application Data
(60) Provisional application No. 63/765,483, filed on Feb. 28, 2025.

(51) Int. Cl. H04B 7/185; H04W 68/00

(52) U.S. Cl. CPC H04B 7/18513; H04B 7/18545; H04W 68/00

(57) ABSTRACT

Certain aspects of the present disclosure provide techniques for wireless communications. An example method includes communicating on a first component carrier (CC) with a first non-terrestrial network entity (NE), wherein the first CC is in a first frequency band; and communicating, while the first CC is established, on a second CC with a second non-terrestrial NE, wherein the second CC is in a second frequency band.

The present Application for Patent claims benefit of U.S. Provisional Application No. 63/765,483, filed Feb. 28, 2025, which is hereby expressly incorporated by reference herein in its entirety.

### INTRODUCTION

Aspects of the present disclosure relate to wireless communications, and more particularly, to techniques for non-terrestrial network improvements.

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method of wireless communication at a user equipment (UE). The method includes communicating on a first component carrier (CC) with a first non-terrestrial network entity (NE), wherein the first CC is in a first frequency band; and communicating, while the first CC is established, on a second CC with a second non-terrestrial NE, wherein the second CC is in a second frequency band.

Certain aspects provide a method of wireless communication at a first non-terrestrial NE. The method includes establishing a first CC with a UE, wherein the first CC is in a first frequency band; and transmitting, to a second non-terrestrial NE, configuration information associated with a network-side carrier aggregation (CA) configuration for the UE, the network-side CA configuration including a second CC between the second non-terrestrial NE and the UE in a second frequency band.

Certain aspects provide a method of wireless communication at a UE. The method includes registering with a first network system that is associated with a first core network architecture; and registering, while maintaining a first registration status with the first network system, with a second network system that is associated with a second core network architecture, wherein registering with the second network system is based on at least one of: a timer relative to a previous registration with the second network system, or location information relative to the previous registration.

Certain aspects provide a method of wireless communication at a core network entity. The method includes identifying a first registration status of a UE with regard to a first network system having a core network architecture and a second registration status of the UE with regard to a second network system having a second core network architecture, wherein the second registration status is based on at least one of: a timer relative to a previous registration of the UE with a second network entity or the second core network architecture, or location information relative to the previous registration; and paging the UE on the first network system and the second network system in accordance with the first registration status and the second registration status.

Certain aspects provide a method of wireless communication at a UE. The method includes establishing, in a terrestrial band, a connection with a non-terrestrial NE; and transmitting a communication, using Doppler pre-compensation, to the non-terrestrial NE via the connection, wherein the communication includes one or more muted tones based on the Doppler pre-compensation.

Certain aspects provide a method of wireless communication at a UE. The method includes communicating on a first CC with a first non-terrestrial NE, wherein the first CC is in a first frequency band; and communicating, while the first CC is active, on a second CC with a second non-terrestrial NE, wherein the second CC is in a second frequency band, wherein the first frequency band is a terrestrial band and the second frequency band is a mobile satellite service band.

Certain aspects provide an apparatus configured for wireless communication. The apparatus includes a processing system that includes one or more processors and one or more memories coupled with the one or more processors. The processing system is configured to cause a UE to communicate on a first component carrier (CC) with a first non-terrestrial NE, wherein the first CC is in a first frequency band; and communicate, while the first CC is active, on a second CC with a second non-terrestrial NE, wherein the second CC is in a second frequency band.

Certain aspects provide an apparatus configured for wireless communication. The apparatus includes a processing system that includes one or more processors and one or more memories coupled with the one or more processors. The processing system is configured to cause a first non-terrestrial network entity to establish a first component carrier (CC) with a user equipment (UE), wherein the first CC is in a first frequency band; and transmit, to a second non-terrestrial NE, configuration information associated with a network-side carrier aggregation (CA) configuration for the UE, the network-side CA configuration including a second CC between the second non-terrestrial NE and the UE in a second frequency band.

Certain aspects provide an apparatus configured for wireless communication. The apparatus includes a processing system that includes one or more processors and one or more memories coupled with the one or more processors. The processing system is configured to cause a UE to register with a first network system that is associated with a first core network architecture; and register, while maintaining a first registration status with the first network system, with a second network system that is associated with a second core network architecture, wherein registering with the second network system is based on at least one of: a timer relative to a previous registration with the second network system, or location information relative to the previous registration.

Certain aspects provide an apparatus configured for wireless communication. The apparatus includes a processing system that includes one or more processors and one or more memories coupled with the one or more processors. The processing system is configured to cause a core network entity to identify a first registration status of a user equipment (UE) with regard to a first network system having a first core network architecture and a second registration status of the UE with regard to a second network system having a second core network architecture, wherein the second registration status is based on at least one of: a timer relative to a previous registration of the UE with a second network entity or the second core network architecture, or location information relative to the previous registration; and page the UE on the first network system and the second network system in accordance with the first registration status and the second registration status.

Certain aspects provide an apparatus configured for wireless communication. The apparatus includes a processing system that includes one or more processors and one or more memories coupled with the one or more processors. The processing system is configured to cause a UE to establish, in a terrestrial band, a connection with a non-terrestrial network entity (NE); and transmit a communication, using Doppler pre-compensation, to the non-terrestrial NE via the connection, wherein the communication includes one or more muted tones based on the Doppler pre-compensation.

Certain aspects provide an apparatus configured for wireless communication. The apparatus includes a processing system that includes one or more processors and one or more memories coupled with the one or more processors. The processing system is configured to cause a UE to communicate on a first CC with a first non-terrestrial NE, wherein the first CC is in a first frequency band; and communicate, while the first CC is active, on a second CC with a second non-terrestrial NE, wherein the second CC is in a second frequency band, wherein the first frequency band is a terrestrial band and the second frequency band is a mobile satellite service band.

Certain aspects provide one or more non-transitory computer-readable media comprising executable instructions that, when executed by one or more processors of a UE, cause the UE to perform operations comprising communicating on a first component carrier (CC) with a first non-terrestrial network entity (NE), wherein the first CC is in a first frequency band; and communicating, while the first CC is established, on a second CC with a second non-terrestrial NE, wherein the second CC is in a second frequency band.

Certain aspects provide one or more non-transitory computer-readable media comprising executable instructions that, when executed by one or more processors of a first non-terrestrial NE, cause the first non-terrestrial NE to perform operations comprising establishing a first CC with a UE, wherein the first CC is in a first frequency band; and transmitting, to a second non-terrestrial NE, configuration information associated with a network-side carrier aggregation (CA) configuration for the UE, the network-side CA configuration including a second CC between the second non-terrestrial NE and the UE in a second frequency band.

Certain aspects provide one or more non-transitory computer-readable media comprising executable instructions that, when executed by one or more processors of a UE, cause the UE to perform operations comprising registering with a first network system that is associated with a first core network architecture; and registering, while maintaining a first registration status with the first network system, with a second network system that is associated with a second core network architecture, wherein registering with the second network system is based on at least one of: a timer relative to a previous registration with the second network system, or location information relative to the previous registration.

Certain aspects provide one or more non-transitory computer-readable media comprising executable instructions that, when executed by one or more processors of a core NE, cause the core to perform operations comprising identifying a first registration status of a UE with regard to a first network system having a core network architecture and a second registration status of the UE with regard to a second network system having a second core network architecture, wherein the second registration status is based on at least one of: a timer relative to a previous registration of the UE with a second network entity or the second core network architecture, or location information relative to the previous registration; and paging the UE on the first network system and the second network system in accordance with the first registration status and the second registration status.

Certain aspects provide one or more non-transitory computer-readable media comprising executable instructions that, when executed by one or more processors of a UE, cause the UE to perform operations comprising establishing, in a terrestrial band, a connection with a non-terrestrial NE; and transmitting a communication, using Doppler pre-compensation, to the non-terrestrial NE via the connection, wherein the communication includes one or more muted tones based on the Doppler pre-compensation.

Certain aspects provide one or more non-transitory computer-readable media comprising executable instructions that, when executed by one or more processors of a UE, cause the UE to perform operations comprising communicating on a first CC with a first non-terrestrial NE, wherein the first CC is in a first frequency band; and communicating, while the first CC is active, on a second CC with a second non-terrestrial NE, wherein the second CC is in a second frequency band, wherein the first frequency band is a terrestrial band and the second frequency band is a mobile satellite service band.

Certain aspects provide an apparatus comprising means for communicating on a first component carrier (CC) with a first non-terrestrial network entity (NE), wherein the first CC is in a first frequency band; and means for communicating, while the first CC is established, on a second CC with a second non-terrestrial NE, wherein the second CC is in a second frequency band.

Certain aspects provide an apparatus comprising means for establishing a first CC with a UE, wherein the first CC is in a first frequency band; and means for transmitting, to a second non-terrestrial NE, configuration information associated with a network-side carrier aggregation (CA) configuration for the UE, the network-side CA configuration including a second CC between the second non-terrestrial NE and the UE in a second frequency band.

Certain aspects provide an apparatus comprising means for registering with a first network system that is associated with a first core network architecture; and means for registering, while maintaining a first registration status with the first network system, with a second network system that is associated with a second core network architecture, wherein registering with the second network system is based on at least one of: a timer relative to a previous registration with the second network system, or location information relative to the previous registration.

Certain aspects provide an apparatus comprising means for identifying a first registration status of a UE with regard to a first network system having a core network architecture and a second registration status of the UE with regard to a second network system having a second core network architecture, wherein the second registration status is based on at least one of: a timer relative to a previous registration of the UE with a second network entity or the second core network architecture, or location information relative to the previous registration; and means for paging the UE on the first network system and the second network system in accordance with the first registration status and the second registration status.

Certain aspects provide an apparatus comprising means for establishing, in a terrestrial band, a connection with a non-terrestrial NE; and means for transmitting a communication, using Doppler pre-compensation, to the non-terrestrial NE via the connection, wherein the communication includes one or more muted tones based on the Doppler pre-compensation.

Certain aspects provide an apparatus comprising means for communicating on a first CC with a first non-terrestrial NE, wherein the first CC is in a first frequency band; and communicating, while the first CC is active, on a second CC with a second non-terrestrial NE, wherein the second CC is in a second frequency band, wherein the first frequency band is a terrestrial band and the second frequency band is a mobile satellite service band.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 illustrates an example service-based architecture of a core network (CN).

FIG. 6 depicts an example non-terrestrial network (NTN).

FIG. 7 depicts a process flow for communications in a network.

FIG. 8 depicts a process flow for communications in a network.

FIG. 9 depicts a process flow for communications in a network.

FIG. 10 depicts a method for wireless communications.

FIG. 11 depicts another method for wireless communications.

FIG. 12 depicts another method for wireless communications.

FIG. 13 depicts another method for wireless communications.

FIG. 14 depicts another method for wireless communications.

FIG. 15 depicts aspects of an example communications device.

FIG. 16 depicts aspects of an example communications device.

FIG. 17 depicts aspects of an example communications device.

FIG. 18 depicts aspects of an example communications device.

FIG. 19 depicts aspects of an example communications device.

FIG. 20 depicts a method for wireless communications.

### DETAILED DESCRIPTION

Aspects of the present disclosure provide apparatuses, methods, processing systems, and computer-readable mediums for carrier aggregation or dual registration in non-terrestrial networks (NTNs).

Certain wireless communication systems (e.g., Evolved Universal Terrestrial Radio Access (E-UTRA) systems, 5G New Radio (NR) systems, and/or future wireless communication systems) may facilitate communications coverage via a Non-terrestrial network (NTN), such as a spaceborne (e.g., satellite) and/or airborne (e.g., airship, balloon, etc.) platform that provides wireless connectivity to a user equipment (UE). An NTN is a network in which connectivity is provided, at least in part, by an NTN entity (NTNE).

NTNs involve various differences relative to terrestrial networks. For example, an NTNE moves at a high velocity and is associated with an elevation angle (e.g., an angle from a horizon to the NTNE) that changes over time, leading to Doppler effects and varying time delays in communication. As another example, some forms of NTN communication are associated with low data rates or bandwidth, particularly uplink communication which can be constrained by a transmit power of a UE (thus involving the deployment of redundant transmission, long slot lengths, and so on). As another example, different NTNEs may have different orbits, leading to differences in the Doppler effects and time delays between NTNEs. On the other hand, terrestrial networks are characterized by stationary (or relatively slow) NEs.

As one example of such a difference, different frequency bands for wireless communication may have different properties. For example, low bands (e.g., frequency bands with a lower center frequency or frequency range) may have better coverage (quantified in the form of a lower minimum elevation angle (MEA), which indicates a lowest elevation angle at which a connection between a UE and an NTNE can be maintained), improved building penetration, and improved persistence (e.g., percentage of time service is available in a particular location) relative to a higher frequency band such as an L band. However, such higher frequency bands may have more spectrum available for NTN communication (for example, due to relatively wider bandwidths and lower utilization of such higher frequency bands), which results in higher peak data rates and higher system capacity. Thus, communication on only one of a lower band or a higher band may provide suboptimal performance in terms of coverage, data rate, and system capacity.

As another example of such a difference, an NTN may provide various forms of communication, including narrowband NTN (NB-NTN) and a wideband NTN (which may, for example, include NR-NTN). NB-NTN is a technology that provides for NTN communication between a UE and an NTN on a narrowband. For example, NB-NTN may support narrowband Internet of Things communication over an NTN, whereas wideband NTN may support communication on a wider bandwidth and/or at a higher data rate than NB-NTN. In some aspects, NB-NTN may support retransmission schemes, longer slot lengths, robust channel coding, or the like. These different forms of communication may perform well in different scenarios. For example, NB-NTN may provide good coverage within a building, whereas wideband NTN may provide higher data rates and increased bandwidth. Furthermore, a situation may arise in which a UE moves frequently between wideband NTN and NB-NTN coverage, which may involve a new registration every time the coverage of the UE switches between wideband NTN and NB-NTN. For example, the UE may go down to a lower floor of a building, where only NB-NTN signals can be received. As soon as the UE goes up one floor, NR-NTN would become available. This may lead to a situation where the UE is frequently registering with, and dropping registrations of (e.g., deregister with regard to), various NTNs, which may make it difficult for paging to consistently reach the UE and may consume UE and network resources.

As another example of such a difference, a UE communicating with an NTNE may use Doppler pre-compensation. Doppler pre-compensation is a frequency shift applied to an uplink transmission to offset the Doppler shift in the frequency domain due to movement of the NTNE relative to the UE. However, a situation may arise in which the Doppler pre-compensation causes a frequency of the uplink transmission to shift out of an acceptable range, such as a range defined by an out-of-band emissions limit. An out-of-band emissions limit defines a maximum permitted power level of emissions that a transmitter can produce outside of a band or channel of the transmitter. Thus, flexibility of NTN communication could be improved, such as a range of Doppler pre-compensations that can be applied or a variety of bands that can be used for NTN communication.

Some aspects of the present disclosure relate generally to carrier aggregation (CA) implemented at multiple NTNEs, such as different satellites. For example, in some aspects, a UE, a first NTNE, and a second NTNE communicate using a CA configuration, with a first (e.g., one or more) component carrier(s) (CC(s)) between the UE and the first NTNE and a second (e.g., one or more) CC(s) between the UE and the second NTNE while the first CC is active (e.g., established). After being established, the first CC may be referred to as being active until the first CC is deconfigured. Notably, the first CC is in a first frequency band and the second CC is in a second frequency band different from the first frequency band. For example, the first frequency band may be lower than the second frequency band. As another example, the first band may be a terrestrial low band (e.g., a sub 1 gigahertz (GHz) band) and the second band may be a mid band (e.g., an L band, an S band, a C band, an X band, a Kᵤ band, a K band, a Kₐ band, a band between 1.2 GHz and 2 GHz, a band between 1450 kilohertz (kHz) and 1550 kHz, or the like). In this way, the UE and NTNEs can communicate on the first CC with improved coverage relative to the second CC, and can communicate on the second CC with a higher data rate relative to the first CC. The first CC and the second CC can both be downlink CCs (e.g., for downlink CA), or one or more of the first CC or the second CC may be an uplink CC (e.g., for uplink CA).

Some aspects of the present disclosure relate generally to joint registration and paging between multiple network systems having different core network (CN) architectures. For example, a UE may register with a first network system (such as an NB-NTN network system) having a first CN architecture. “Registering” may include sending a registration request to a core network entity of the first network system and establishing a session for the UE. A “network system” may include a particular core network and, optionally, an access network (e.g., one or more NTNEs). In some aspects, a network system may be associated with a given public land mobile network identifier. After registering with the first network system and while maintaining a registration status (e.g., staying registered, maintaining a registration management registered state) with the first network system, the UE may register with a second network system that is associated with a second CN architecture. The UE may perform this registration in accordance with at least one of a timer (e.g., relative to a previous registration with the second network system) or location information (e.g., a restriction such that the UE will only register with the second network system if the UE has moved to a new location such as a new tracking area). In some aspects, the first network system may be an NB-NTN network system (e.g., a network system implementing NB-NTN via one or more NTNEs) and the second network system may include a wideband NTN system (e.g., a network system implementing NTN communication via one or more NTNEs). By providing the timer-based or location-information-based registration on the second network system, aspects described herein reduce the occurrence of frequent switching between registrations and reduce ambiguity with regard to where (e.g., on which network system) a UE should be paged.

Some aspects described herein relate to uplink transmission with Doppler pre-compensation based on an out-of-band emissions limit. For example, a UE may establish a connection with an NTNE in a terrestrial band (e.g., a band specified for terrestrial communication). Such a terrestrial band may have an out-of-band emissions limit to which the UE is expected to adhere. A Doppler pre-compensation may cause a transmission of the UE to occur near an edge of the terrestrial band, which may lead to violation of the out-of-band emissions limit. Aspects described herein provide for a transmission by the UE to have one or more muted tones based on the Doppler pre-compensation. A muted tone is a resource element that is configured with zero transmit power, such that the UE does not perform a transmission on the resource element. For example, if the Doppler pre-compensation indicates a frequency increase for the communication, the one or more muted tones may occur at a top edge of the terrestrial band (e.g., at or adjacent to a highest frequency included in the terrestrial band). As another example, if the Doppler pre-compensation indicates a frequency decrease for the communication, the one or more muted tones may occur at a bottom edge of the terrestrial band (e.g., at or adjacent to a lowest frequency included in the terrestrial band). This may be implemented for low-Earth orbit (LEO) satellites and terrestrial bands, which are subject to stringent out-of-band emissions limits.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

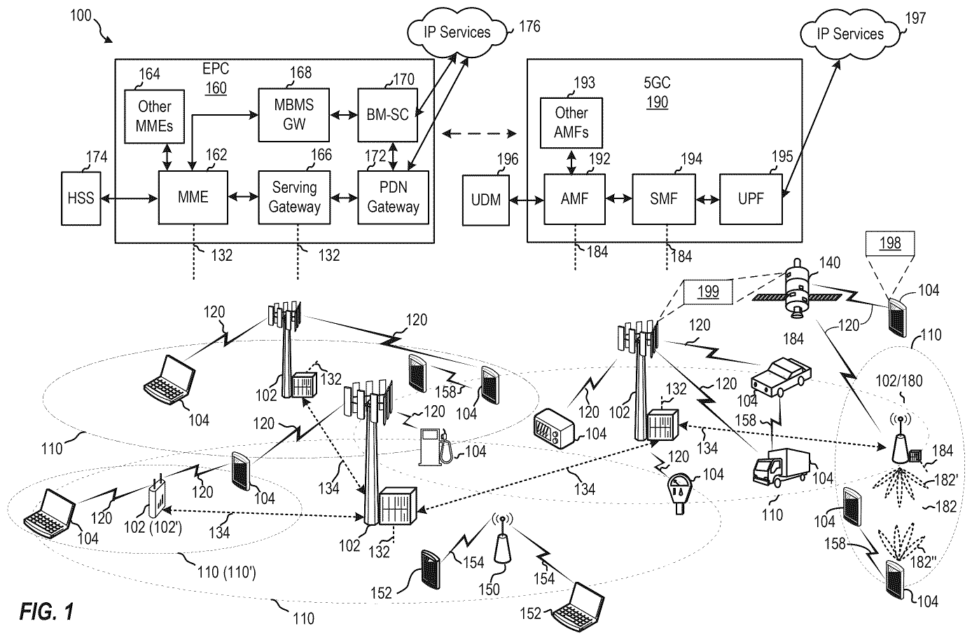

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

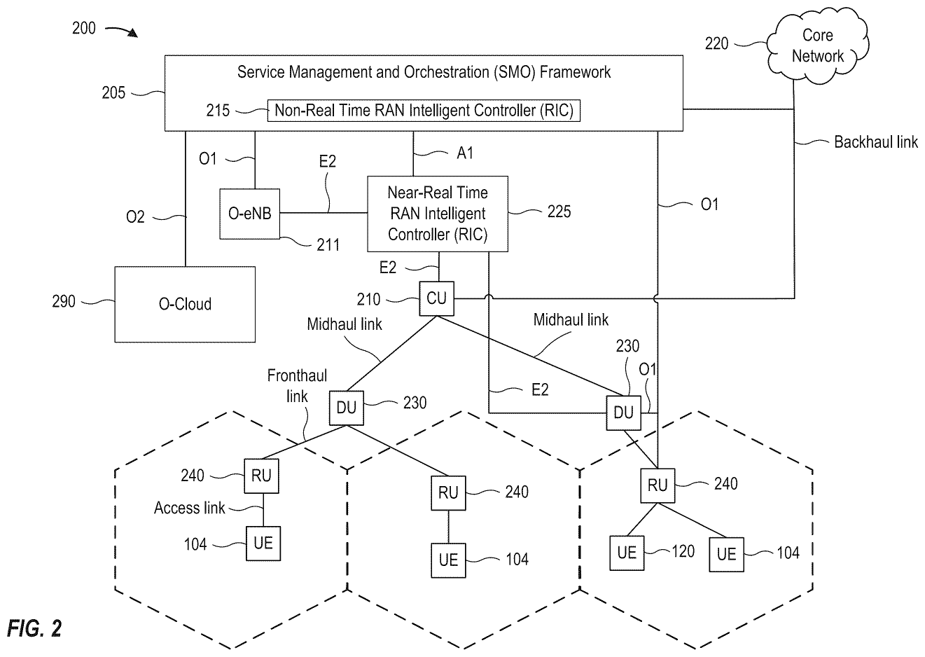

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

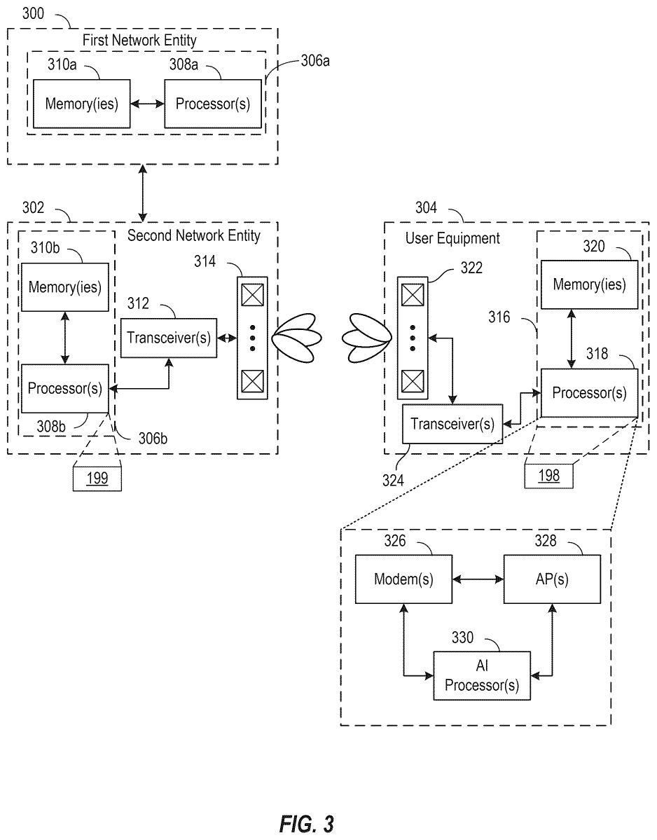

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

A UE 104 or 304 may include a communication manager 198. The communication manager 198 may perform operations relating to NTN improvement, such as CA among NTNEs, joint registration, or muting of tones based on an out-of-band emissions rule. A BS 102, or a network entity 300/302 may include a communication manager 199. The communication manager 199 may perform operations relating to NTN improvement, such as CA among NTNEs, joint registration, or muting of tones based on an out-of-band emissions rule.

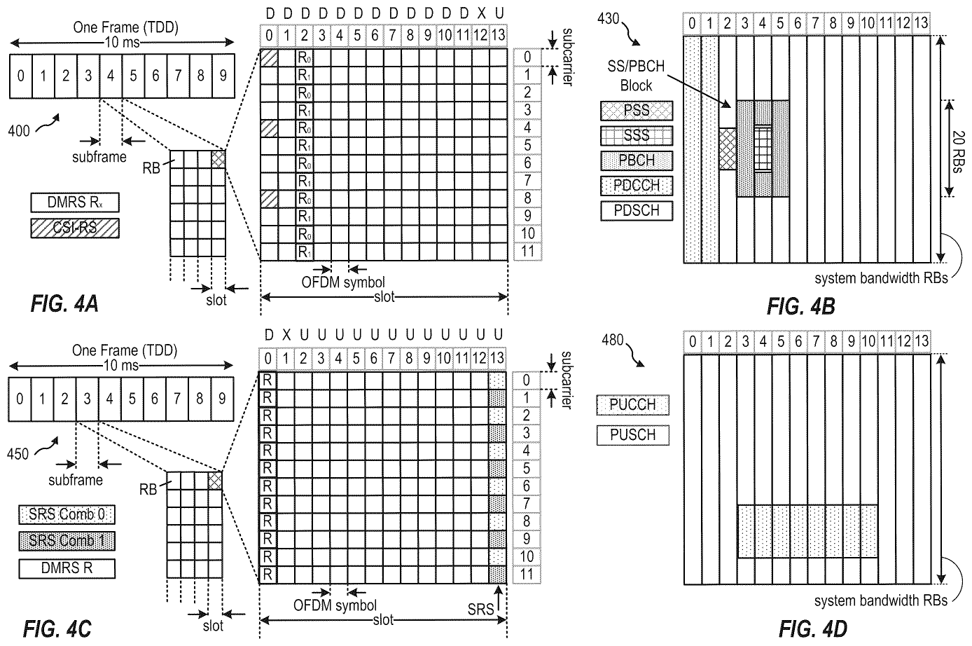

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

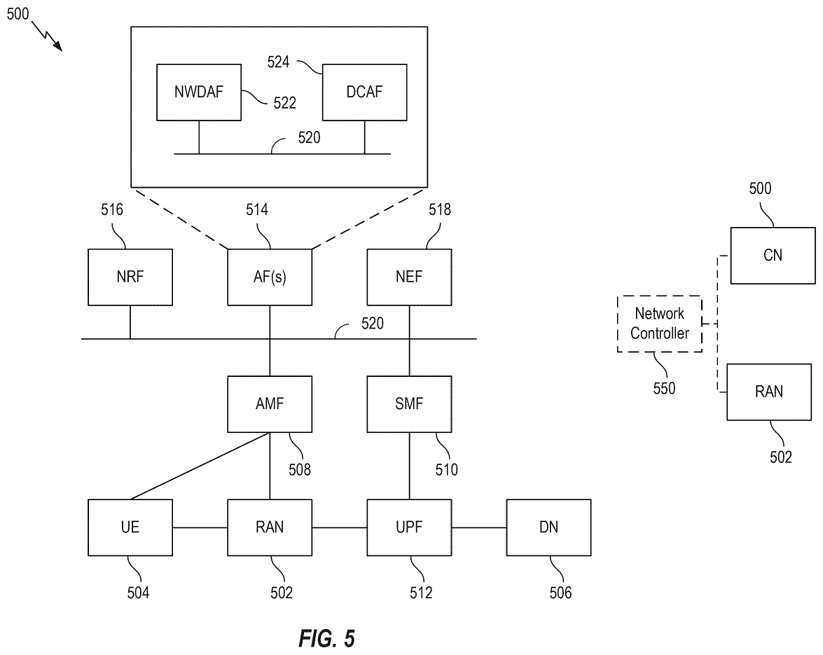

FIG. 5 illustrates an example architecture of a CN 500. In this example, the CN 500 is in communication with a RAN 502 and a UE 504, for example, as described herein with respect to FIG. 1. The CN 500 may facilitate communications between the UE 504 and a data network 506, which may include, for example, the internet and/or an intranet.

The CN 500 includes an access and mobility management function (AMF) 508, a session management function (SMF) 510, a user plane function (UPF) 512, one or more application functions (AFs) 514, a network repository function (NRF) 516, and a network exposure function (NEF) 518.

Network functions of the CN 500 are in communication with each other via a common bus 520. The common bus 520 is used for communicating control plane traffic among the network functions. Control plane traffic may include control signaling such as mobility management and/or session management signaling, whereas user plane traffic may include application data between a UE and an application server. In this example, the network functions include the AMF 508, SMF 510, AF(s) 514, NRF 516, and NEF 518. Note that the CN 500 may include other network functions in addition to or instead of these examples. A network function may be referred to herein as a core network entity.

The architecture may enable a cloud-based CN. For example, any of the various functions of the CN 500 may be or include a logical function that is hosted at or on a computational device, such as a network entity, computer, server, virtual server, etc. One or more of the functions may be virtualized to allow virtual network entities to operate using a shared computing platform (e.g., a cloud computing platform). For example, a network entity may be configured to host, perform, and/or support any of the various functions of the CN 500. In some aspects, any of the various functions of the CN 500 may correspond to a network entity and/or a shared computing platform that hosts the given function. Note that other architectures for the CN may be used in addition to or instead of the architecture, such as a reference point architecture, a roaming architecture, etc.

As examples, the AMF 508 may perform registration management, connection management, reachability management, mobility management, access authentication, and access authorization of the UE 504. The SMF 510 may perform protocol data unit (PDU) session management, such as allocating and managing the UE internet protocol (IP) address. The UPF 512 routes and forwards user plane traffic between the RAN 502 and the data network 506.

The AF(s) 514 is a control plane function that interacts with other functions (e.g., the AMF 508, SMF 510, and UPF 512) to provide support for one or more specific services. For example, the AF(s) 514 may include a control plane function for managing a video streaming service, a social media service, and/or a video game service. In some cases, an AF 514 may be co-located at a network entity (such as a base station, CU, DU, and/or RU) to facilitate reduced latency and/or reduce transport bandwidth between the network entity and the service.

The NRF 516 may serve as a repository that allows network functions to register their services and then allows other network functions to discover those services and corresponding network function. As an example, for network function registration, upon initial activation and/or reconfiguration, a network function (e.g., a specific AF 514) may register the services that are managed at the network function with the NRF 516, and the NRF 516 may store the network function profile for later discovery by other network functions. For network function discovery, a network function may request for information associated with a specific network function from the NRF 516, and the NRF 516 may provide the requested information to the network function.

The NEF 518 may support secure exposure of capabilities and events associated with the CN 500 and/or UE 504 to an external network entity (not shown) and may enable secure provision of information from the external network entity to CN 500. For example, network function capabilities and events may be securely exposed by the NEF 518 to support, for example, third party services (e.g., analytics monitoring of a streaming service), application functions, edge computing, etc.

Note that any of the network entities (e.g., the AMF 508, SMF 510, UPF 512, AF(s) 514, NRF 516, and/or NEF 518) in the CN 500 may perform other functions in addition to or instead of those described for the respective entity.

In certain aspects, the CN 500 may include a data analytics framework having a network data analytics function (NWDAF) 522 and a data collection application function (DCAF) 524. The NWDAF 522 may provide analytics to network functions in the CN 500 and/or a network controller 550. The analytics may include, for example, performance statistics and/or predictions associated with the operations of the CN 500 and/or the RAN 502. As an example, the NWDAF 522 may predict the mobility of the UE, for example, as a prediction of a route a UE will take through a network coverage area and the corresponding network entities that can service communications with the UE on such a route. As another example, the NWDAF 522 may provide network slice monitoring, which may include the monitoring of network performance and quality of service on one or more network slices and/or one or more users/subscribers. The network slice monitoring may allow a communications service provider to meet the terms of a service licensing agreement, for example, which specifies certain levels of QoS for a subscriber or user. In certain aspects, the NWDAF 522 may perform ML model training on ML model(s) deployed at or in the CN 500 and/or the RAN 502, for example, ML models used for network analytics.

The network controller 550 may configure and manage the CN 500 and/or the RAN 502. The network controller may enable the operations, administration, and maintenance of the CN 500 and/or the RAN 502. For example, the network controller 550 may collect performance data, events, and/or alarms reported by the CN 500 and/or the RAN 502 and provide visualizations of such data. The network controller 550 may provide a platform for provisioning and/or maintaining the CN 500 and/or the RAN 502. In certain cases, the network controller 550 may be or include the Near-RT RIC 225, the Non-RT RIC 215, and/or the SMO Framework 205, for example, in an Open RAN or cloud-based RAN architecture. In some cases, the network controller 550 may be or include an operations, administration, and maintenance (OAM) host or server.

The NWDAF 522 may interact with the DCAF 524 to collect data from UE application(s) (e.g., a streaming service application, a gaming service application, a social media service application, etc.) running at the UE 504 as an input for analytics generation and/or ML model training at the NWDAF 522. A data collection request from NWDAF may trigger the DCAF 524 to collect data from a UE application. The UE application running at the UE 504 may establish a connection to the DCAF 524 over user (or data) plane via a PDU session, and the DCAF 524 communicates with the UE application and collects data from the UE Application.

Reference to a RAN performing certain operations, as discussed herein, may refer to one or more network entities (e.g., a base station, an NTN entity, and/or one or more disaggregated entities thereof) performing the operations. Reference to a CN performing certain operations, as discussed herein, may refer to one or more physical and/or logical network entities (e.g., a network functions and/or application functions) performing the operations.

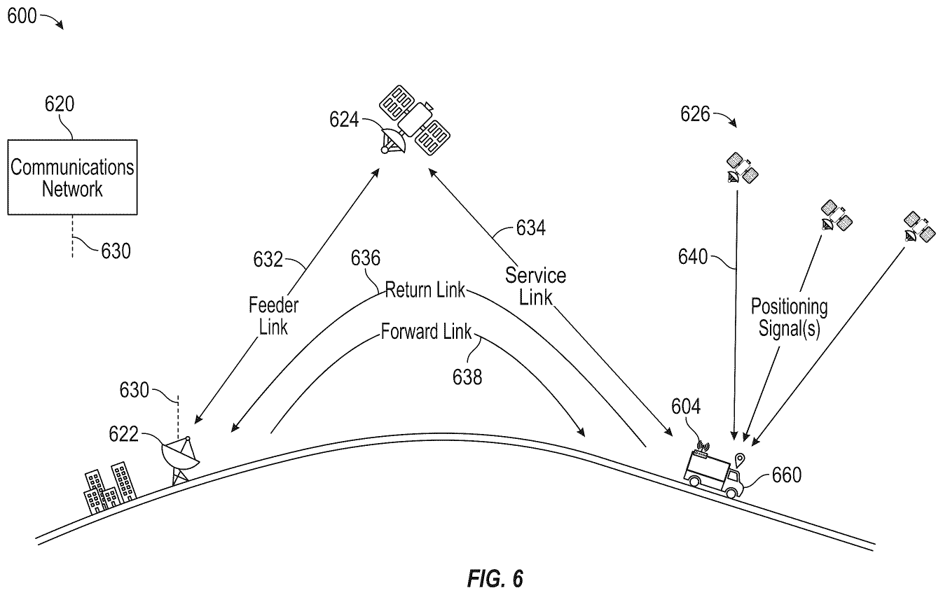

FIG. 6 depicts an example NTN 600. In this example, the NTN 600 includes a communications network 620 (e.g., the EPC 160 and/or the 5GC network 190 of FIG. 1), an NTN gateway 622, and an NTN payload 624. The NTN 600 may facilitate wireless communications with one or more UEs 604 (e.g., the UE 104 of FIG. 1). As an example, the UE 604 may include an IoT sensor and/or identification tag affixed to a vehicle 660. The NTN 600 may allow the UE 604 to be in a coverage area for wireless communications even where the vehicle 660 travels great distances, for example, across one or more countries, or is stationed in certain locations lacking a terrestrial communications network. Note that the NB-IoT UE is an example, and other UEs may be capable of NTN communications.

The NTN gateway 622 may communicate with the communications network 620 via one or more interfaces 630, such as backhaul links including NG interface(s) and/or S1 interface(s) between a RAN and a core network. The interface(s) 630 may include wired and/or wireless connections. The NTN gateway 622 may serve one or more NTN payloads 624.

The NTN payload 624 may be or include one or more airborne platforms (e.g., a drone or balloon) and/or one or more spaceborne platforms (e.g., the satellite 140 as depicted in FIG. 1). The NTN payload 624 may be served by one or more NTN gateways 622. In certain aspects, the NTN payload 624 may include any of various NTN entities and/or platforms that provide radio access through Geosynchronous orbits (GSO), Non-Geosynchronous Orbit (NGSO), which includes Low-Earth Orbit (LEO) and Medium Earth Orbit (MEO), or High Altitude Platform Systems (HAPS).

The NTN payload 624 may transparently forward communications (e.g., the radio protocol) received from the UE 604 (via a service link 634) to the NTN gateway 622 (via a feeder link 632), and/or vice-versa. The NTN gateway 622 and the NTN payload 624 may communicate via a wireless communication link referred to as the feeder link 632, and the NTN payload 624 may communicate with the UE 604 via a wireless communication link referred to as the service link 634. In some cases, the transparent links between the NTN gateway 622 and the UE 604 may be referred to as a return link 636 for communications from the UE 604 to the NTN gateway 622 and as a forward link 638 for communications from the NTN gateway 622 to the UE 604. In certain aspects, for communications from the NTN gateway 622, the NTN payload 624 may change the carrier frequency used on the feeder link 632, before re-transmitting the communications on the service link 634, and/or vice versa (respectively on the feeder link).

The service link 634 may include an Earth-fixed service link, a quasi-Earth-fixed service link, and/or an Earth-moving service link. An Earth-fixed service link may be implemented by beam(s) continuously covering the same geographical area(s) all the time (e.g., the case of GSO satellites). A quasi-Earth-fixed service link may be provisioned by beam(s) covering one geographic area for a limited period and a different geographic area during another period (e.g., the case of NGSO satellites generating steerable beams). An Earth-moving service link may be provisioned by beam(s) with a coverage area that slides over the Earth surface (e.g., the case of NGSO satellites generating fixed or non-steerable beams).

In certain aspects, the UE 604 may be in communication with a global navigation satellite system (GNSS) 626. For example, the UE 604 may receive positioning signal(s) 640 from the GNSS 626, and the positioning signal(s) 640 may provide certain information for synchronizing (e.g., time and/or frequency synchronization) the service link 634. The UE 604 may obtain the location of the NTN payload 624 via system information from the NTN payload 624. The UE 604 may estimate a timing delay and Doppler effects associated with the service link 634 using the positioning signal(s) 640 and the location of the NTN payload 624.

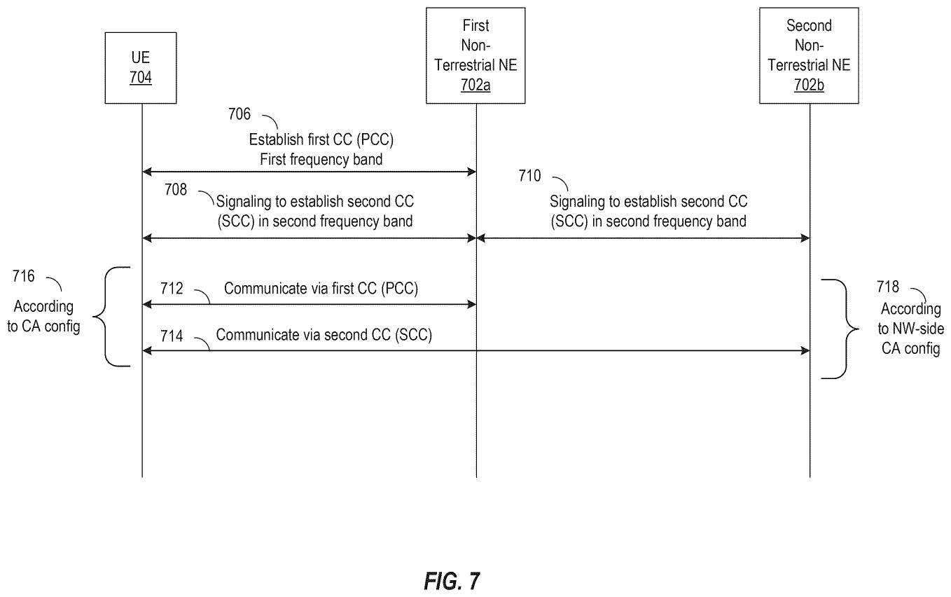

FIG. 7 depicts a process flow 700 for communications in a network between a first NTNE 702a, a second NTNE 702b, and a UE 704. In some aspects, a network entity 702 may be an example of the BS 102 depicted and described with respect to FIG. 1 the first network entity 300 or the second network entity 302 depicted and described with respect to FIG. 3, or a disaggregated base station depicted and described with respect to FIG. 2. Similarly, the UE 704 may be an example of UE 104 depicted and described with respect to FIG. 1 or the UE 304 depicted and described with respect to FIG. 3. However, in other aspects, UE 704 may be another type of wireless communications device and network entity 702 may be another type of network entity or network node, such as those described herein. Note that any operations or signaling illustrated with dashed lines may indicate that that operation or signaling is an optional or alternative example.

In some aspects, the first NTNE 702a comprises a first satellite associated with a gateway (e.g., gateway 622) and the second NTNE 702b comprises a second satellite associated with the gateway. In some aspects, the first NTNE 702a comprises a first satellite associated with a first gateway and the second NTNE comprises a second satellite associated with a second gateway. In some aspects, the first NTNE 702 comprises a first regenerative satellite (e.g., implemented according to a regenerative architecture, including a gNB) and the second NTNE comprises a second regenerative satellite. The first NTNE 702a is implemented at a first satellite and the second NTNE 702b is implemented at a second satellite different from the first satellite.

At 706, the UE 704 and the first NTNE 702a establish a first CC on a first frequency band. Establishing a CC may include configuring the CC, such as via RRC configuration of a center frequency, a bandwidth, a power setting, or the like. After being established, the first CC may be referred to as being active until the first CC is deconfigured. The first CC may be a primary CC, meaning that the first CC can be used for control signaling and data communication.

At 708, the UE 704 and the first NTNE 702a perform signaling relating to establishing a second CC on a second frequency band. The signaling at 708 may be via the first CC. For example, the first NTNE 702a may send, to the UE 704 via the first CC, an RRC configuration that configures the second CC. Additionally, or alternatively, at 710, the first NTNE 702a and the second NTNE 702b perform signaling relating to establishing the second CC on the second frequency band. For example, the first NTNE 702a may send, to the second NTNE 702b, at least part of a network-side CA configuration that indicates a configuration of the second CC, such as a center frequency, a bandwidth, a power setting, or the like. The second CC may be a secondary CC, meaning that the second CC can be used for data communication.

The first frequency band may be lower than the second frequency band (e.g., may have a lower center frequency). For example, the first frequency band may be a terrestrial band (e.g., a sub 1 GHz frequency band, a 700 MHz band, an 800 MHz band, a 900 MHz band, a GSM band, an IoT band, a 433 MHz band, an 868 MHz band, a 915 MHz band, or the like). The second frequency band may include, for example, an L band, an S band, a C band, an X band, a Ku band, a K band, or a Ka band, as defined by the North Atlantic Treaty Organization or the Institute of Electrical and Electronics Engineers. As another example, the second frequency band may be a mobile satellite service (MSS) band, which is a frequency band allocated for communications between mobile earth stations (e.g., UEs) and satellites, such as bands n254, n255, or n256 (as defined by the 3GPP). As another example, the second frequency band may occur in a frequency range of 1.2 to 2.2 GHz, 1 to 2 GHz, 1.5 to 1.6 GHz, 1.4 to 1.6 GHz, or the like.

At 712, the UE 704 and the first NTNE 702a communicate via the first CC. In some aspects, the communication via the first CC is control communication, such as a PUCCH or a PDCCH. In some aspects, the UE 704 may apply a first timing protocol (such as a first hybrid automatic repeat request (HARQ) timing associated with NTN communication) to the communication via the first CC. In some aspects, the UE 704 may apply a first Doppler pre-compensation to the communication via the first CC. At 714, the UE 704 and the second NTNE 702b communicate via the second CC. In some aspects, the communication via the second CC is data communication, such as a PUSCH or a PDSCH. In some aspects, the UE 704 may apply a second timing protocol (such as a second HARQ timing associated with NTN communication) to the communication via the first CC. In some aspects, the UE 704 may apply a second Doppler pre-compensation to the communication via the first CC.

A timing protocol, or a Doppler pre-compensation, may be based on a location or velocity information of a corresponding NTNE 702. For example, the Doppler pre-compensation may be configured to offset Doppler shift due to the velocity of the NTNE 702. As another example, the timing protocol may be configured to time-shift communications such that they are received at the NTNE 702 at an expected time (based on a location and/or velocity information of the NTNE 702).

As shown by 716, the communication via the first CC and the second CC may be in accordance with a CA configuration at the UE 704. For example, the UE 704 may perform control communications via the first CC since the first CC is a primary CC. As another example, the UE 704 may perform data communications via the second CC since the second CC is a secondary CC. As shown by 718, the communication via the first CC and the second CC may be in accordance with a network-side CA configuration. For example, the second NTNE 702b may communicate with the UE 704 via the second CC as a secondary CC according to the network-side CA configuration.

Note that the process flow illustrated in FIG. 7 is an example. Note that aspects of the present disclosure may be performed in various manners via alternative or additional signaling and/or operations. In certain aspects, the operations and/or signaling of FIG. 7 may occur in an order different from that described or depicted, and various actions, operations, and/or signaling may be added, omitted, or combined.

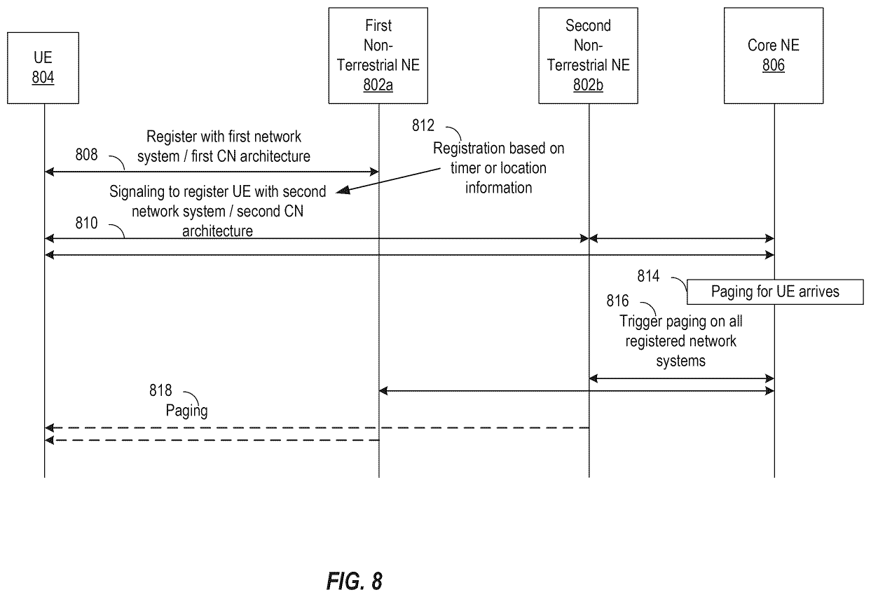

FIG. 8 depicts a process flow 800 for communications in a network between a first NTNE 802a, a second NTNE 802b, a UE 804, and a core NE 806. In some aspects, a network entity 802 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 804 may be an example of UE 104 depicted and described with respect to FIG. 1 or the UE 304 depicted and described with respect to FIG. 3. The core NE 806 may be a network function of a 5G core, a service of a service-based architecture, or an entity of an Evolved Packet Core (EPC). However, in other aspects, UE 804 may be another type of wireless communications device and network entity 802 may be another type of network entity or network node, such as those described herein. Note that any operations or signaling illustrated with dashed lines may indicate that that operation or signaling is an optional or alternative example.

In some aspects, the first NTNE 802a comprises a first satellite associated with a gateway (e.g., gateway 622) and the second NTNE 802b comprises a second satellite associated with the gateway. In some aspects, the first NTNE 802a comprises a first satellite associated with a first gateway and the second NTNE comprises a second satellite associated with a second gateway. In some aspects, the first NTNE 802 comprises a first regenerative satellite (e.g., implemented according to a regenerative architecture, including a gNB) and the second NTNE comprises a second regenerative satellite.

At 808, the UE 804 (e.g., based on communicating with the first NTNE 802a and/or the core NE 806) registers with a first network system (e.g., a first CN, a first public land mobile network) associated with a first CN architecture. The first CN architecture may include an EPC architecture, a 5GC architecture, a 6G core architecture (such as a service based architecture, in which radio functions and core network functions are converged in individual services), or the like.

In some aspects, the first network system is an NB-NTN system associated with an EPC CN architecture. In some aspects, the second network system is a wideband NTN system such as an NR-NTN system associated with a 5G core CN architecture. Such a network system may provide a wider communicating bandwidth and a higher data rate than an NB-NTN system.

At 810, the UE 804 (e.g., based on communicating with the first NTNE 802a, the second NTNE 802b, and/or the core NE 806) registers with a second network system (e.g., a second CN, a second public land mobile network) associated with a second CN architecture. The second CN architecture may include an EPC architecture, a 5GC architecture, a 6G core architecture (such as a service based architecture, in which radio functions and core network functions are converged in individual services), or the like. The second CN architecture may be different than the first CN architecture. The UE 804 may register with the second network system while the UE 804 is registered with the first network system.

As shown by 812, the registration with the second network system may be based on a timer, or may be based on location information. In some aspects, the registration with the second network system is based on the timer. For example, the timer may indicate a length of time, after registering with a given network system (e.g., the second network system), that the UE 804 can again register with the given network system. Additionally, or alternatively, the timer may indicate a length of time for which the UE 804 maintains a registration status of a given network system, and the UE 804 may only register in a network system if the UE 804 has not previously registered with the network system within the length of the timer.

In some aspects, the registration with the second network system is based on the location information. The location information may include a tracking area identifier. For example, the UE may maintain a registration status of a given network system, and may only register with a new network system if the new network system is outside of a tracking area identified by the tracking area identifier. Thus, the UE 804 maintains memory of any prior registration to a network system, and keeps running the timer and remembering the tracking area identifier of the network system.

At 814, paging for the UE 804 arrives at the core NE 806. For example, the core NE 806 may determine that data, a message, or another form of communication is ready for the UE 804. At 816, the core NE 806 triggers paging on all registered network systems (e.g., the first network system and the second network system) for the UE 804. For example, the core NE 806 may trigger paging in all systems in which a valid registration is present. At 818, the first NTNE 802a or the second NTNE 802b pages the UE 804. The UE 804 may monitor for paging on each network system on which the UE has a registration status. Thus, joint paging is implemented, for example, between an NB-NTN system and an NR-NTN system (as non-limiting examples).

Note that the process flow illustrated in FIG. 8 is an example. Note that aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

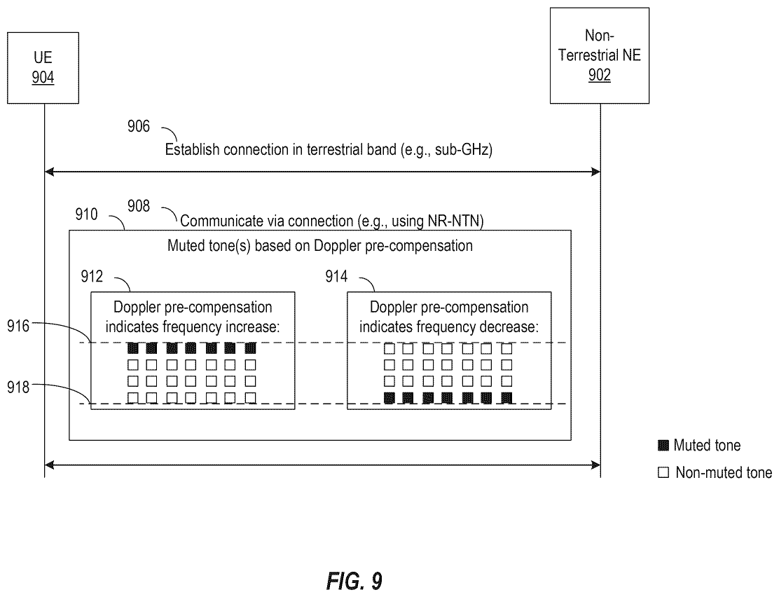

FIG. 9 depicts a process flow 900 for communications in a network between an NTNE 902 and a UE 904. In some aspects, a network entity 902 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 904 may be an example of UE 104 depicted and described with respect to FIG. 1 or the UE 304 depicted and described with respect to FIG. 3. However, in other aspects, UE 904 may be another type of wireless communications device and network entity 902 may be another type of network entity or network node, such as those described herein. Note that any operations or signaling illustrated with dashed lines may indicate that that operation or signaling is an optional or alternative example. In some aspects, the NTNE 902 is a low-Earth orbit (LEO) satellite, such as in a circular orbit at an altitude of 500 to 2000 km.

At 906, the UE 904 and the NTNE 902 establish a connection in a terrestrial band. “Terrestrial band” is defined in connection with FIG. 7. Establishing a connection may include, for example, configuring an RRC connection.

At 908, the UE 904 and the NTNE 902 communicate via the connection, such as using an NR-NTN protocol. As shown, a communication at 908 is transmitted using a Doppler pre-compensation. Furthermore, as shown at 910, the communication includes one or more muted tones (indicated by a black fill) based on the Doppler pre-compensation. For example, as shown at 912, the one or more muted tones may occur at a top edge 916 of the terrestrial band based on the Doppler pre-compensation including a frequency increase for the communication. The top edge of the terrestrial band may be a highest frequency of the terrestrial band, a highest number of frequencies of the terrestrial band, or the like. For example, as shown at 914, the one or more muted tones may occur at a bottom edge 918 of the terrestrial band based on the Doppler pre-compensation including a frequency decrease for the communication. The bottom edge of the terrestrial band may be a lowest frequency of the terrestrial band, a lowest number of frequencies of the terrestrial band, or the like. In some aspects, the UE 904 may identify (e.g., autonomously determine) the one or more muted tones based on the Doppler pre-compensation (e.g., such that the one or more muted tones satisfy an out-of-band emission limitation for the terrestrial band). In some aspects, the NTNE 902 may signal information indicating the one or more muted tones to the UE 904, or may schedule the UE 904 such that the one or more muted tones are muted. In some aspects, the communication may use a timing protocol specific to the NTNE 902 (e.g., as described above with regard to FIG. 8 based on location information or a velocity). In some aspects, the Doppler pre-compensation may be specific to the NTNE 902 (e.g., as described above with regard to FIG. 8, based on location information or a velocity).

Note that the process flow illustrated in FIG. 9 is an example. Note that aspects of the present disclosure may be performed in various manners via alternative or additional signaling and/or operations. In certain aspects, the operations and/or signaling of FIG. 9 may occur in an order different from that described or depicted, and various actions, operations, and/or signaling may be added, omitted, or combined.

Any of the communications described herein, for example with respect to FIGS. 7-14, can be implemented using codecs that are suitable for (e.g. optimized for) satellite systems, such as AGVC. Furthermore, the network entities (e.g., NTNEs) described herein may support transcoding for devices not capable of using such a codec.

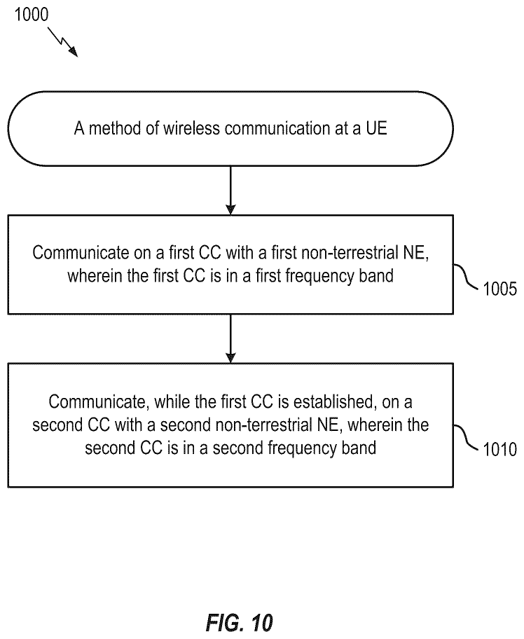

FIG. 10 shows a method 1000 for wireless communication at a UE, such as UE 104 of FIG. 1 or UE 304 of FIG. 3.

Method 1000 begins at block 1005 with communicating on a first CC with a first non-terrestrial NE, wherein the first CC is in a first frequency band.

Method 1000 then proceeds to block 1010 with communicating, while the first CC is established, on a second CC with a second non-terrestrial NE, wherein the second CC is in a second frequency band.

In some aspects, communicating with the first non-terrestrial NE comprises applying at least one of: a first timing protocol, or a first Doppler pre-compensation.

In some aspects, the first timing protocol or the first Doppler pre-compensation is based on a first location or first velocity information of the first non-terrestrial NE.

In some aspects, communicating with the second non-terrestrial NE comprises applying at least one of: a second timing protocol different than the first timing protocol, or a second Doppler pre-compensation different than the first Doppler pre-compensation.

In some aspects, the second timing protocol or second first Doppler pre-compensation is based on a second location or second velocity information of the second non-terrestrial NE.

In some aspects, the first CC and the second CC are associated with a CA configuration in which the first CC is a primary CC and the second CC is a secondary CC.

In some aspects, block 1005 includes performing control communication to configure the second CC for the second non-terrestrial NE.

In some aspects, the first frequency band is lower than the second frequency band.

In some aspects, the second frequency band comprises one of: an L band, an S band, a C band, an X band, a Ku band, a K band, or a Ka band.

In some aspects, the first frequency band is a terrestrial band and the second frequency band is a mobile satellite service band.

In some aspects, at least one of the first CC or the second CC is a downlink CC.

In some aspects, at least one of the first CC or the second CC is an uplink CC.

In some aspects, communicating the first non-terrestrial NE and communicating with the second non-terrestrial NE are based on a non-terrestrial network protocol.

In some aspects, the first non-terrestrial NE comprises a first satellite associated with a gateway and the second non-terrestrial NE comprises a second satellite associated with the gateway.

In some aspects, the first non-terrestrial NE comprises a first satellite associated with a first gateway and the second non-terrestrial NE comprises a second satellite associated with a second gateway.

In some aspects, the first non-terrestrial NE comprises a first regenerative satellite and the second non-terrestrial NE comprises a second regenerative satellite.

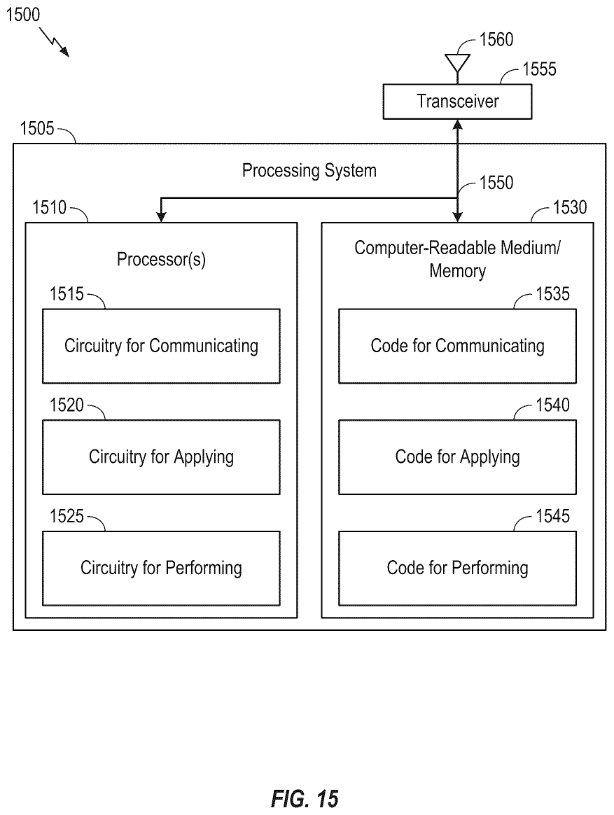

In some aspect, method 1000, or any aspect related to it, may be performed by an apparatus, such as communications device 1500 of FIG. 15, which includes various components operable, configured, or adapted to perform the method 1000. Communications device 1500 is described below in further detail.

Note that FIG. 10 is just one example of a method, and other methods including fewer, additional, or alternative operations are possible consistent with this disclosure.

### Example Operations of a Non-Terrestrial Network Entity

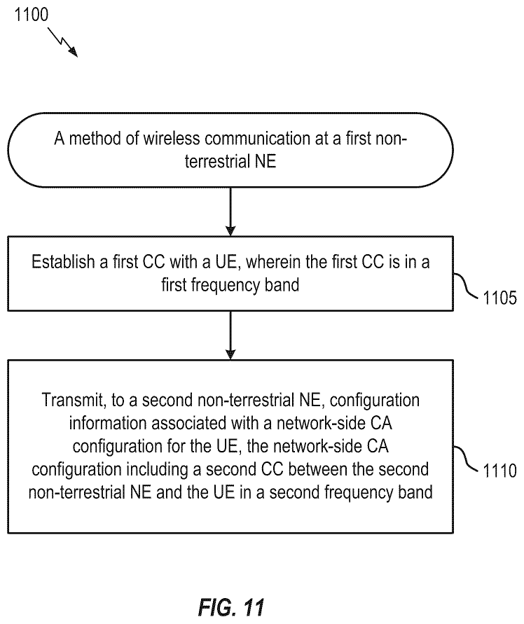

FIG. 11 shows a method 1100 for wireless communication at a first non-terrestrial NE, such as BS 102 of FIG. 1, a first network entity 300 or second network entity 302 of FIG. 3, or a disaggregated base station as discussed with respect to FIG. 2.

Method 1100 begins at block 1105 with establishing a first CC with a UE, wherein the first CC is in a first frequency band.

Method 1100 then proceeds to block 1110 with transmitting, to a second non-terrestrial NE, configuration information associated with a network-side CA configuration for the UE, the network-side CA configuration including a second CC between the second non-terrestrial NE and the UE in a second frequency band. In some aspects, the first NTNE may represent (e.g., correspond to, be) a first CC and the second NTNE may represent (e.g., correspond to, be) a second CC. In some aspects, the first NTNE and the second NTNE may be the same network entity, or may be associated with the same network entity (e.g., gNB). In some aspects, the first frequency band is a terrestrial band and the second frequency band is a mobile satellite service band.

In some aspects, in the network-side CA configuration, the first CC is a primary CC and the second CC is a secondary CC.

In some aspects, communicating on the first CC further comprises performing control communication to establish the second CC with the second non-terrestrial NE.

In some aspects, the first frequency band is lower than the second frequency band.

In some aspects, the second frequency band comprises one of: an L band, an S band, a C band, an X band, a Ku band, a K band, or a Ka band.

In some aspects, the first frequency band is a terrestrial band and the second frequency band is a mobile satellite service band.

In some aspects, at least one of the first CC or the second CC is a downlink CC.

In some aspects, at least one of the first CC or the second CC is an uplink CC.

In some aspects, the first CC is associated with a first timing protocol or a first Doppler pre-compensation.

In some aspects, the second CC is associated with a second timing protocol or a second Doppler pre-compensation.

In some aspects, the first non-terrestrial NE comprises a first satellite associated with a gateway and the second non-terrestrial NE comprises a second satellite associated with the gateway.

In some aspects, the first non-terrestrial NE comprises a first satellite associated with a first gateway and the second non-terrestrial NE comprises a second satellite associated with a second gateway.

In some aspects, the first non-terrestrial NE comprises a first regenerative satellite and the second non-terrestrial NE comprises a second regenerative satellite.

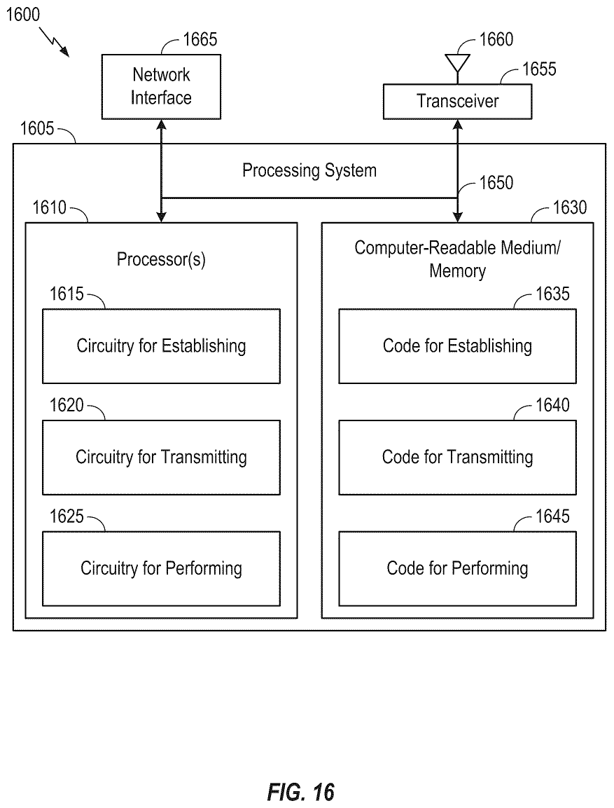

In some aspect, method 1100, or any aspect related to it, may be performed by an apparatus, such as communications device 1600 of FIG. 16, which includes various components operable, configured, or adapted to perform the method 1100. Communications device 1600 is described below in further detail.

Note that FIG. 11 is just one example of a method, and other methods including fewer, additional, or alternative operations are possible consistent with this disclosure.

### Example Operations of a User Equipment

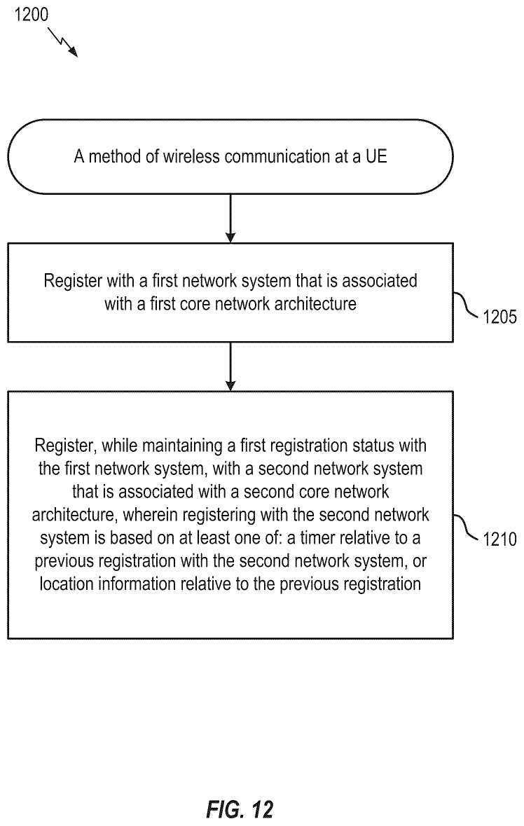

FIG. 12 shows a method 1200 for wireless communication at a UE, such as UE 104 of FIG. 1 or UE 304 of FIG. 3.

Method 1200 begins at block 1205 with registering with a first network system that is associated with a first core network architecture.

Method 1200 then proceeds to block 1210 with registering, while maintaining a first registration status with the first network system, with a second network system that is associated with a second core network architecture, wherein registering with the second network system is based on at least one of: a timer relative to a previous registration with the second network system, or location information relative to the previous registration.

In some aspects, the first network system is associated with a narrowband non-terrestrial network.

In some aspects, the second network system is associated with a non-terrestrial network.

In some aspects, the first core network architecture is an Evolved Packet Core architecture and the second core network architecture is a 5G Core architecture.

In some aspects, one of the first core network architecture or the second core network architecture comprises a service based architecture.

In some aspects, block 1210 includes registering with the second network system based on not having been registered with the second network system within a length of the timer.

In some aspects, block 1210 includes registering with the second network system based on not having been registered with the second network system in a tracking area indicated by the location information.

In some aspects, method 1200 further includes monitoring for paging according to the first registration status and a second registration status associated with the second network system.

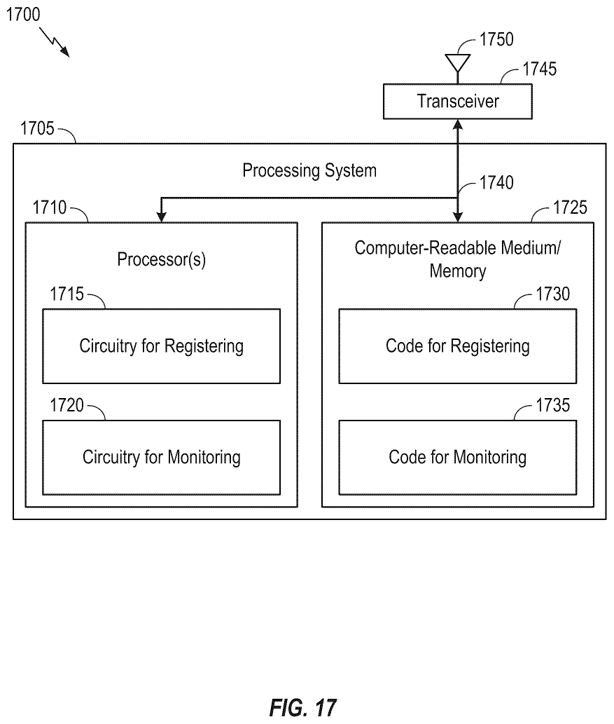

In some aspect, method 1200, or any aspect related to it, may be performed by an apparatus, such as communications device 1700 of FIG. 17, which includes various components operable, configured, or adapted to perform the method 1200. Communications device 1700 is described below in further detail.

Note that FIG. 12 is just one example of a method, and other methods including fewer, additional, or alternative operations are possible consistent with this disclosure.

### Example Operations of a Core Network Entity

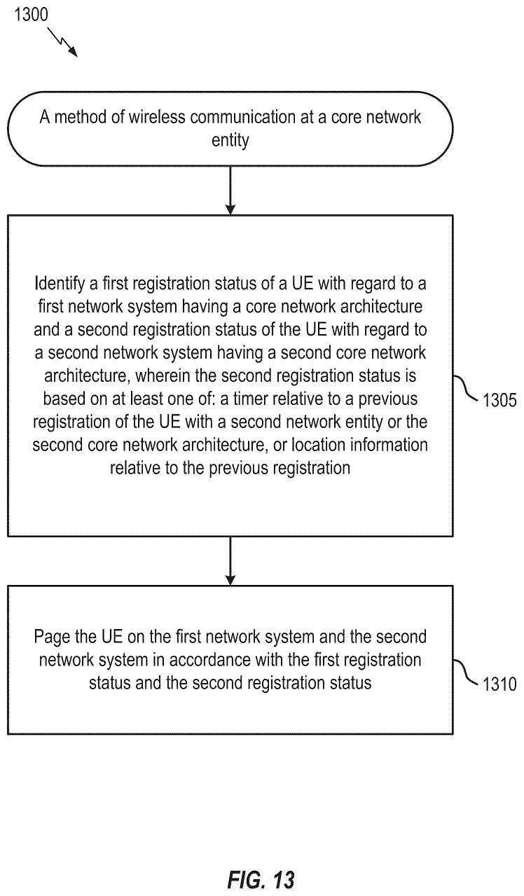

FIG. 13 shows a method 1300 for wireless communication at a core network entity, such as BS 102 of FIG. 1, a first network entity 300 or second network entity 302 of FIG. 3, or a disaggregated base station as discussed with respect to FIG. 2.

Method 1300 begins at block 1305 with identifying a first registration status of a UE with regard to a first network system having a core network architecture and a second registration status of the UE with regard to a second network system having a second core network architecture, wherein the second registration status is based on at least one of: a timer relative to a previous registration of the UE with a second network entity or the second core network architecture, or location information relative to the previous registration.

Method 1300 then proceeds to block 1310 with paging the UE on the first network system and the second network system in accordance with the first registration status and the second registration status.

In some aspects, the first network system is associated with a narrowband non-terrestrial network.

In some aspects, the second network system is associated with a non-terrestrial network.

In some aspects, the first core network architecture is an Evolved Packet Core architecture and the second core network architecture is a 5G Core architecture.

In some aspects, one of the first core network architecture or the second core network architecture comprises a service based architecture.

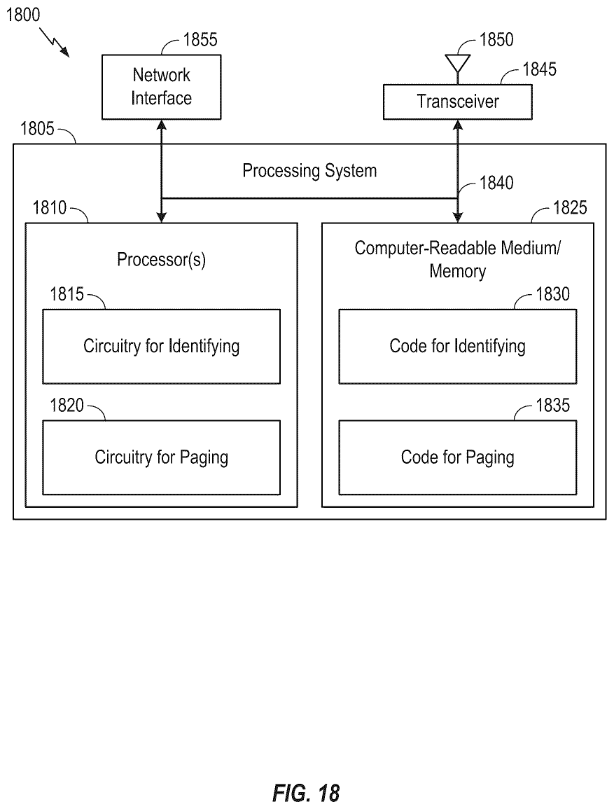

In some aspect, method 1300, or any aspect related to it, may be performed by an apparatus, such as communications device 1800 of FIG. 18, which includes various components operable, configured, or adapted to perform the method 1300. Communications device 1800 is described below in further detail.

Note that FIG. 13 is just one example of a method, and other methods including fewer, additional, or alternative operations are possible consistent with this disclosure.

### Example Operations of a User Equipment

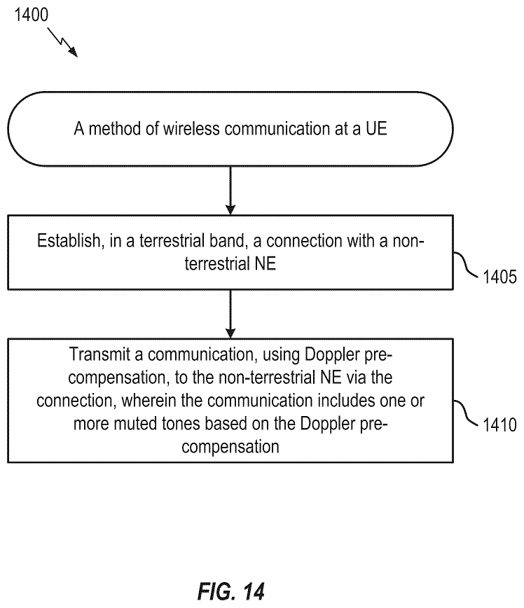

FIG. 14 shows a method 1400 for wireless communication at a UE, such as UE 104 of FIG. 1 or UE 304 of FIG. 3.

Method 1400 begins at block 1405 with establishing, in a terrestrial band, a connection with a non-terrestrial NE.

Method 1400 then proceeds to block 1410 with transmitting a communication, using Doppler pre-compensation, to the non-terrestrial NE via the connection, wherein the communication includes one or more muted tones based on the Doppler pre-compensation.

In some aspects, the one or more muted tones occur at a top edge of the terrestrial band based on the Doppler pre-compensation including a frequency increase for the communication.

In some aspects, the one or more muted tones occur at a bottom edge of the terrestrial band based on the Doppler pre-compensation including a frequency decrease for the communication.

In some aspects, method 1400 further includes identifying the one or more muted tones based on the Doppler pre-compensation.

In some aspects, method 1400 further includes receiving signaling indicating the one or more muted tones.

In some aspects, the one or more muted tones are based on a out-of-band emissions rule for the terrestrial band.

In some aspects, the NTN protocol is a New Radio NTN protocol.

In some aspects, communicating with the non-terrestrial NE via the connection comprises communicating using at least one of a timing protocol or the Doppler pre-compensation specific to the non-terrestrial NE in accordance with the NTN protocol.

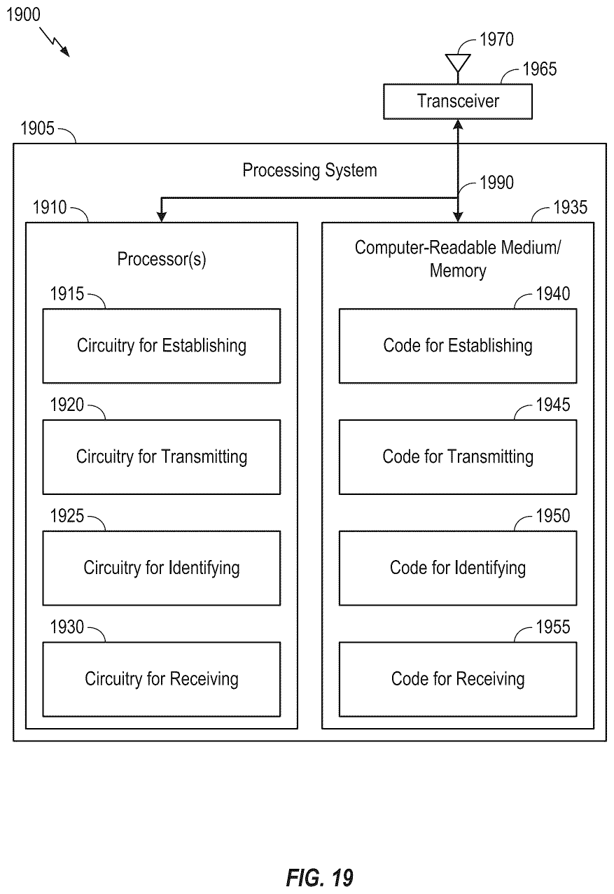

In some aspect, method 1400, or any aspect related to it, may be performed by an apparatus, such as communications device 1900 of FIG. 19, which includes various components operable, configured, or adapted to perform the method 1400. Communications device 1900 is described below in further detail.

Note that FIG. 14 is just one example of a method, and other methods including fewer, additional, or alternative operations are possible consistent with this disclosure.

### Example Operations of a Network Entity

FIG. 15 depicts aspects of an example communications device 1500 configured for wireless communications. In some aspects, communications device 1500 is a user equipment, such as UE 104 described above with respect to FIG. 1 or UE 304

### Described With Respect to FIG. 3

The communications device 1500 includes a processing system 1505 coupled to a transceiver 1555 (e.g., a transmitter and/or a receiver). The transceiver 1555 is configured to transmit and receive signals for the communications device 1500 via an antenna 1560, such as the various signals as described herein. The processing system 1505 may be configured to perform processing functions for the communications device 1500, including processing signals received and/or to be transmitted by the communications device 1500.

The processing system 1505 includes one or more processors 1510 and a computer-readable medium/memory 1530. In various aspects, the one or more processors 1510 may be representative of the one or more processors 318 described with respect to FIG. 3. The one or more processors 1510 are coupled to a computer-readable medium/memory 1530 via a bus 1550. In some aspects, the computer-readable medium/memory 1530 may be representative of the one or more memories 320 described with respect to FIG. 3. The computer-readable medium/memory 1530 is a non-transitory computer-readable medium/memory. In certain aspects, the computer-readable medium/memory 1530 is configured to store instructions (e.g., computer-executable code), that when executed by the one or more processors 1510, cause the one or more processors 1510 to perform the method 1000 described with respect to FIG. 10, or any aspect related to it, including any operations described in relation to FIG. 10. Note that reference to a processor performing a function of communications device 1500 may include one or more processors performing that function of communications device 1500, such as in a distributed fashion.

In the depicted example, computer-readable medium/memory 1530 stores code (e.g., executable instructions), including code for communicating 1535, code for applying 1540, and code for performing 1545. Processing of the code 1535-1545 may enable and cause the communications device 1500 to perform the method 1000 described with respect to FIG. 10, or any aspect related to it. For example, in some aspects, code for communicating 1535 includes code for communicating on a first CC with a first non-terrestrial NE, wherein the first CC is in a first frequency band. In some aspects, code for communicating 1535 includes code for communicating, while the first CC is established, on a second CC with a second non-terrestrial NE, wherein the second CC is in a second frequency band.

The one or more processors 1510 include circuitry configured to implement (e.g., execute) the code stored in the computer-readable medium/memory 1530, including circuitry for communicating 1515, circuitry for applying 1520, and circuitry for performing 1525. Processing with circuitry 1515-1525 may enable and cause the communications device 1500 to perform the method 1000 described with respect to FIG. 10, or any aspect related to it. For example, in some aspects, circuitry for communicating 1515 includes circuitry for communicating on a first CC with a first non-terrestrial NE, wherein the first CC is in a first frequency band. In some aspects, circuitry for communicating 1515 includes circuitry for communicating, while the first CC is established, on a second CC with a second non-terrestrial NE, wherein the second CC is in a second frequency band.

More generally, means for communicating, transmitting, sending or outputting for transmission may include the one or more transceivers 324, one or more antenna 322 and/or processing system 316 of the UE 304 illustrated in FIG. 3, transceiver 1555 and/or antenna 1560 of the communications device 1500 in FIG. 15, and/or one or more processors 1510 of the communications device 1500 in FIG. 15. Means for communicating, receiving or obtaining may include the one or more transceivers 324, one or more antennas 322, and/or processing system 316 of the UE 304 illustrated in FIG. 3, transceiver 1555 and/or antenna 1560 of the communications device 1500 in FIG. 15, and/or one or more processors 1510 of the communications device 1500 in FIG. 15.

FIG. 16 depicts aspects of an example communications device configured for wireless communications. In some aspects, communications device 1600 is a network entity, such as BS 102 of FIG. 1, first network entity 300 or second network entity 302 of FIG. 3, or a disaggregated base station as discussed with respect to FIG. 2.

The communications device 1600 includes a processing system 1605 coupled to a transceiver 1655 (e.g., a transmitter and/or a receiver) and/or a network interface 1665. The transceiver 1655 is configured to transmit and receive signals for the communications device 1600 via an antenna 1660, such as the various signals as described herein. The network interface 1665 is configured to obtain and send signals for the communications device 1600 via communications link(s), such as a backhaul link, midhaul link, and/or fronthaul link as described herein, such as with respect to FIG. 2. The processing system 1605 may be configured to perform processing functions for the communications device 1600, including processing signals received and/or to be transmitted by the communications device 1600.

The processing system 1605 includes one or more processors 1610 and a computer-readable medium/memory 1630. In various aspects, one or more processors 1610 may be representative of the one or more processors 308, as described with respect to FIG. 3. The one or more processors 1610 are coupled to the computer-readable medium/memory 1630 via a bus 1650. In certain aspects, the computer-readable medium/memory 1630 is configured to store instructions (e.g., computer-executable code), including code 1635-1645, that when executed by the one or more processors 1610, cause the one or more processors 1610 to perform the method 1100 described with respect to FIG. 11, or any aspect related to it, including any operations described in relation to FIG. 11. The computer-readable medium/memory 1630 is a non-transitory computer-readable medium/memory. Note that reference to a processor of communications device 1600 performing a function may include one or more processors of communications device 1600 performing that function, such as in a distributed fashion.

In the depicted example, the computer-readable medium/memory 1630 stores code (e.g., executable instructions), including code for establishing 1635, code for transmitting 1640, and code for performing 1645. Processing of the code 1635-1645 may enable and cause the communications device 1600 to perform the method 1100 described with respect to FIG. 11, or any aspect related to it. For example, in some aspects, code for establishing 1635 includes code for establishing a first CC with a UE, wherein the first CC is in a first frequency band. In some aspects, code for transmitting 1640 includes code for transmitting, to a second non-terrestrial NE, configuration information associated with a network-side CA configuration for the UE, the network-side CA configuration including a second CC between the second non-terrestrial NE and the UE in a second frequency band.

The one or more processors 1610 include circuitry configured to implement (e.g., execute) the code stored in the computer-readable medium/memory 1630, including circuitry for establishing 1615, circuitry for transmitting 1620, and circuitry for performing 1625. Processing with circuitry 1615-1625 may enable and cause the communications device 1600 to perform the method 1100 described with respect to FIG. 11, or any aspect related to it. For example, in some aspects, circuitry for establishing 1615 includes circuitry for establishing a first CC with a UE, wherein the first CC is in a first frequency band. In some aspects, circuitry for transmitting 1620 includes circuitry for transmitting, to a second non-terrestrial NE, configuration information associated with a network-side CA configuration for the UE, the network-side CA configuration including a second CC between the second non-terrestrial NE and the UE in a second frequency band.

Various components of the communications device 1600 may provide means for performing the method 1100 described with respect to FIG. 11, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1655, antenna 1660, and/or network interface 1665 of the communications device 1600 in FIG. 16, and/or one or more processors 1610 of the communications device 1600 in FIG. 16. Means for communicating, receiving or obtaining may include the one or more transceivers 312, one or more antennas 314, and/or processing system 306 of the first network entity 300 or the second network entity 302 illustrated in FIG. 3, transceiver 1655, antenna 1660, and/or network interface 1665 of the communications device 1600 in FIG. 16, and/or one or more processors 1610 of the communications device 1600 in FIG. 16.

FIG. 17 depicts aspects of an example communications device 1700 configured for wireless communications. In some aspects, communications device 1700 is a user equipment, such as UE 104 described above with respect to FIG. 1 or UE 304 described with respect to FIG. 3.

The communications device 1700 includes a processing system 1705 coupled to a transceiver 1745 (e.g., a transmitter and/or a receiver). The transceiver 1745 is configured to transmit and receive signals for the communications device 1700 via an antenna 1750, such as the various signals as described herein. The processing system 1705 may be configured to perform processing functions for the communications device 1700, including processing signals received and/or to be transmitted by the communications device 1700.

The processing system 1705 includes one or more processors 1710 and a computer-readable medium/memory 1725. In various aspects, the one or more processors 1710 may be representative of the one or more processors 318 described with respect to FIG. 3. The one or more processors 1710 are coupled to a computer-readable medium/memory 1725 via a bus 1740. In some aspects, the computer-readable medium/memory 1725 may be representative of the one or more memories 320 described with respect to FIG. 3. The computer-readable medium/memory 1725 is a non-transitory computer-readable medium/memory. In certain aspects, the computer-readable medium/memory 1725 is configured to store instructions (e.g., computer-executable code), that when executed by the one or more processors 1710, cause the one or more processors 1710 to perform the method 1200 described with respect to FIG. 12, or any aspect related to it, including any operations described in relation to FIG. 12. Note that reference to a processor performing a function of communications device 1700 may include one or more processors performing that function of communications device 1700, such as in a distributed fashion.

In the depicted example, computer-readable medium/memory 1725 stores code (e.g., executable instructions), including code for registering 1730 and code for monitoring 1735. Processing of the code 1730 and 1735 may enable and cause the communications device 1700 to perform the method 1200 described with respect to FIG. 12, or any aspect related to it. For example, in some aspects, code for registering 1730 includes code for registering with a first network system that is associated with a first core network architecture. In some aspects, code for registering 1730 includes code for registering, while maintaining a first registration status with the first network system, with a second network system that is associated with a second core network architecture, wherein registering with the second network system is based on at least one of: a timer relative to a previous registration with the second network system, or location information relative to the previous registration.

The one or more processors 1710 include circuitry configured to implement (e.g., execute) the code stored in the computer-readable medium/memory 1725, including circuitry for registering 1715 and circuitry for monitoring 1720. Processing with circuitry 1715 and 1720 may enable and cause the communications device 1700 to perform the method 1200 described with respect to FIG. 12, or any aspect related to it. For example, in some aspects, circuitry for registering 1715 includes circuitry for registering with a first network system that is associated with a first core network architecture. In some aspects, circuitry for registering 1715 includes circuitry for registering, while maintaining a first registration status with the first network system, with a second network system that is associated with a second core network architecture, wherein registering with the second network system is based on at least one of: a timer relative to a previous registration with the second network system, or location information relative to the previous registration.

More generally, means for communicating, transmitting, sending or outputting for transmission may include the one or more transceivers 324, one or more antenna 322 and/or processing system 316 of the UE 304 illustrated in FIG. 3, transceiver 1745 and/or antenna 1750 of the communications device 1700 in FIG. 17, and/or one or more processors 1710 of the communications device 1700 in FIG. 17. Means for communicating, receiving or obtaining may include the one or more transceivers 324, one or more antennas 322, and/or processing system 316 of the UE 304 illustrated in FIG. 3, transceiver 1745 and/or antenna 1750 of the communications device 1700 in FIG. 17, and/or one or more processors 1710 of the communications device 1700 in FIG. 17.

FIG. 18 depicts aspects of an example communications device configured for wireless communications. In some aspects, communications device 1800 is a network entity, such as BS 102 of FIG. 1, first network entity 300 or second network entity 302 of FIG. 3, or a disaggregated base station as discussed with respect to FIG. 2. In some aspects, communications device 1800 is a core network entity, as described above with respect to FIGS. 1, 5, and 8.

The communications device 1800 includes a processing system 1805 coupled to a transceiver 1845 (e.g., a transmitter and/or a receiver) and/or a network interface 1855. The transceiver 1845 is configured to transmit and receive signals for the communications device 1800 via an antenna 1850, such as the various signals as described herein. The network interface 1855 is configured to obtain and send signals for the communications device 1800 via communications link(s), such as a backhaul link, midhaul link, and/or fronthaul link as described herein, such as with respect to FIG. 2. The processing system 1805 may be configured to perform processing functions for the communications device 1800, including processing signals received and/or to be transmitted by the communications device 1800.

The processing system 1805 includes one or more processors 1810 and a computer-readable medium/memory 1825. In various aspects, one or more processors 1810 may be representative of the one or more processors 308, as described with respect to FIG. 3. The one or more processors 1810 are coupled to the computer-readable medium/memory 1825 via a bus 1840. In certain aspects, the computer-readable medium/memory 1825 is configured to store instructions (e.g., computer-executable code), including code 1830 and 1835, that when executed by the one or more processors 1810, cause the one or more processors 1810 to perform the method 1300 described with respect to FIG. 13, or any aspect related to it, including any operations described in relation to FIG. 13. The computer-readable medium/memory 1825 is a non-transitory computer-readable medium/memory. Note that reference to a processor of communications device 1800 performing a function may include one or more processors of communications device 1800 performing that function, such as in a distributed fashion.

In the depicted example, the computer-readable medium/memory 1825 stores code (e.g., executable instructions), including code for identifying 1830 and code for paging 1835. Processing of the code 1830 and 1835 may enable and cause the communications device 1800 to perform the method 1300 described with respect to FIG. 13, or any aspect related to it. For example, in some aspects, code for identifying 1830 includes code for identifying a first registration status of a UE with regard to a first network system having a core network architecture and a second registration status of the UE with regard to a second network system having a second core network architecture, wherein the second registration status is based on at least one of: a timer relative to a previous registration of the UE with a second network entity or the second core network architecture, or location information relative to the previous registration. In some aspects, code for paging 1835 includes code for paging the UE on the first network system and the second network system in accordance with the first registration status and the second registration status.

The one or more processors 1810 include circuitry configured to implement (e.g., execute) the code stored in the computer-readable medium/memory 1825, including circuitry for identifying 1815 and circuitry for paging 1820. Processing with circuitry 1815 and 1820 may enable and cause the communications device 1800 to perform the method 1300 described with respect to FIG. 13, or any aspect related to it. For example, in some aspects, circuitry for identifying 1815 includes circuitry for identifying a first registration status of a UE with regard to a first network system having a core network architecture and a second registration status of the UE with regard to a second network system having a second core network architecture, wherein the second registration status is based on at least one of: a timer relative to a previous registration of the UE with a second network entity or the second core network architecture, or location information relative to the previous registration. In some aspects, circuitry for paging 1820 includes circuitry for paging the UE on the first network system and the second network system in accordance with the first registration status and the second registration status.

Various components of the communications device 1800 may provide means for performing the method 1300 described with respect to FIG. 13, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1845, antenna 1850, and/or network interface 1855 of the communications device 1800 in FIG. 18, and/or one or more processors 1810 of the communications device 1800 in FIG. 18. Means for communicating, receiving or obtaining may include the one or more transceivers 312, one or more antennas 314, and/or processing system 306 of the first network entity 300 or the second network entity 302 illustrated in FIG. 3, transceiver 1845, antenna 1850, and/or network interface 1855 of the communications device 1800 in FIG. 18, and/or one or more processors 1810 of the communications device 1800 in FIG. 18.

FIG. 19 depicts aspects of an example communications device 1900 configured for wireless communications. In some aspects, communications device 1900 is a user equipment, such as UE 104 described above with respect to FIG. 1 or UE 304 described with respect to FIG. 3.

The communications device 1900 includes a processing system 1905 coupled to a transceiver 1965 (e.g., a transmitter and/or a receiver). The transceiver 1965 is configured to transmit and receive signals for the communications device 1900 via an antenna 1970, such as the various signals as described herein. The processing system 1905 may be configured to perform processing functions for the communications device 1900, including processing signals received and/or to be transmitted by the communications device 1900.

The processing system 1905 includes one or more processors 1910 and a computer-readable medium/memory 1935. In various aspects, the one or more processors 1910 may be representative of the one or more processors 318 described with respect to FIG. 3. The one or more processors 1910 are coupled to a computer-readable medium/memory 1935 via a bus 1990. In some aspects, the computer-readable medium/memory 1935 may be representative of the one or more memories 320 described with respect to FIG. 3. The computer-readable medium/memory 1935 is a non-transitory computer-readable medium/memory. In certain aspects, the computer-readable medium/memory 1935 is configured to store instructions (e.g., computer-executable code), that when executed by the one or more processors 1910, cause the one or more processors 1910 to perform the method 1400 described with respect to FIG. 14, or any aspect related to it, including any operations described in relation to FIG. 14. Note that reference to a processor performing a function of communications device 1900 may include one or more processors performing that function of communications device 1900, such as in a distributed fashion.

In the depicted example, computer-readable medium/memory 1940 stores code (e.g., executable instructions), including code for establishing 1945, code for transmitting 1950, code for identifying 1955, code for receiving 1960, and code for communicating 1965. Processing of the code 1945-1965 may enable and cause the communications device 1900 to perform the method 1400 described with respect to FIG. 14, or any aspect related to it. For example, in some aspects, code for establishing 1945 includes code for establishing, in a terrestrial band, a connection with a non-terrestrial NE. In some aspects, code for transmitting 1950 includes code for transmitting a communication, using Doppler pre-compensation, to the non-terrestrial NE via the connection, wherein the communication includes one or more muted tones based on the Doppler pre-compensation.

The one or more processors 1910 include circuitry configured to implement (e.g., execute) the code stored in the computer-readable medium/memory 1940, including circuitry for establishing 1915, circuitry for transmitting 1920, circuitry for identifying 1925, circuitry for receiving 1930, and circuitry for communicating 1935. Processing with circuitry 1915-1935 may enable and cause the communications device 1900 to perform the method 1400 described with respect to FIG. 14, or any aspect related to it. For example, in some aspects, circuitry for establishing 1915includes circuitry for establishing, in a terrestrial band, a connection with a non-terrestrial NE. In some aspects, circuitry for transmitting 1920 includes circuitry for transmitting a communication, using Doppler pre-compensation, to the non-terrestrial NE via the connection, wherein the communication includes one or more muted tones based on the Doppler pre-compensation.

More generally, means for communicating, transmitting, sending or outputting for transmission may include the one or more transceivers 324, one or more antenna 322 and/or processing system 316 of the UE 304 illustrated in FIG. 3, transceiver 1965 and/or antenna 1970 of the communications device 1900 in FIG. 19, and/or one or more processors 1910 of the communications device 1900 in FIG. 19. Means for communicating, receiving or obtaining may include the one or more transceivers 324, one or more antennas 322, and/or processing system 316 of the UE 304 illustrated in FIG. 3, transceiver 1965 and/or antenna 1970 of the communications device 1900 in FIG. 19, and/or one or more processors 1910 of the communications device 1900 in FIG. 19.

### Example Operations of a User Equipment

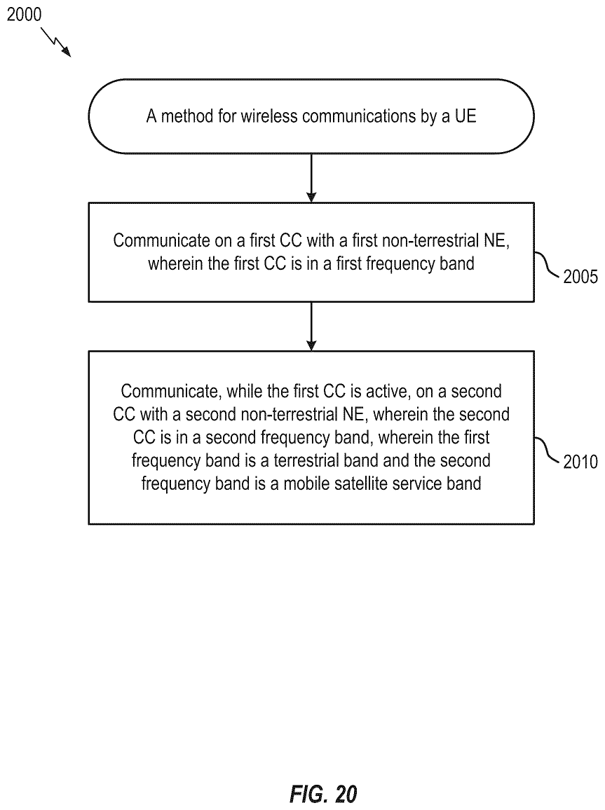

FIG. 20 shows a method 2000 for wireless communications by a UE, such as UE 104 of FIG. 1 or UE 304 of FIG. 3.

Method 2000 begins at block 2005 with communicating on a first CC with a first non-terrestrial NE, wherein the first CC is in a first frequency band.

Method 2000 then proceeds to block 2010 with communicating, while the first CC is active, on a second CC with a second non-terrestrial NE, wherein the second CC is in a second frequency band, wherein the first frequency band is a terrestrial band and the second frequency band is a mobile satellite service band.

In some aspects, the second frequency band comprises one of: an L band, an S band a C band, an X band a Ku band, a K band, or a Ka band.

In some aspects, block 2005 includes applying at least one of: a first timing protocol, or a first Doppler pre-compensation.

In some aspects, the first timing protocol or the first Doppler pre-compensation is based on a first location or first velocity information of the first non-terrestrial NE.

In some aspects, block 2010 includes applying at least one of: a second timing protocol different than the first timing protocol, or a second Doppler pre-compensation different than the first Doppler pre-compensation.

In some aspects, the second timing protocol or the second Doppler pre-compensation is based on a second location or second velocity information of the second non-terrestrial NE.

In some aspects, the first CC and the second CC are associated with a CA configuration in which the first CC is a primary CC and the second CC is a secondary CC.

In some aspects, block 2005 includes performing control communication to configure the second CC for the second non-terrestrial NE.

In some aspects, the first frequency band is lower than the second frequency band.

In some aspects, at least one of the first CC or the second CC is a downlink CC.

In some aspects, at least one of the first CC or the second CC is an uplink CC.

In some aspects, communicating with the first non-terrestrial NE and communicating with the second non-terrestrial NE are based on a non-terrestrial network protocol.

In some aspects, the first non-terrestrial NE comprises a first satellite associated with a gateway and the second non-terrestrial NE comprises a second satellite associated with the gateway.

In some aspects, the first non-terrestrial NE comprises a first satellite associated with a first gateway and the second non-terrestrial NE comprises a second satellite associated with a second gateway.

In some aspects, the first non-terrestrial NE comprises a first regenerative satellite and the second non-terrestrial NE comprises a second regenerative satellite.

In some aspects, the first non-terrestrial NE and the second non-terrestrial NE are a same non-terrestrial NE.

In some aspects, method 2000, or any aspect related to it, may be performed by an apparatus, such as communications device 1500 of FIG. 15, which includes various components operable, configured, or adapted to perform the method 2000. Communications device 1500 is described below in further detail.

Note that FIG. 20 is just one example of a method, and other methods including fewer, additional, or alternative operations are possible consistent with this disclosure.

### Example Clauses

Implementation examples are described in the following numbered clauses:

Clause 1: A method of wireless communication at a UE, comprising: communicating on a first CC with a first non-terrestrial NE, wherein the first CC is in a first frequency band; and communicating, while the first CC is established, on a second CC with a second non-terrestrial NE, wherein the second CC is in a second frequency band.

Clause 2: The method of Clause 1, wherein communicating with the first non-terrestrial NE comprises applying at least one of: a first timing protocol, or a first Doppler pre-compensation.

Clause 3: The method of Clause 2, wherein the first timing protocol or the first Doppler pre-compensation is based on a first location or first velocity information of the first non-terrestrial NE.

Clause 4: The method of any one of Clauses 1-3, wherein communicating with the second non-terrestrial NE comprises applying at least one of: a second timing protocol different than the first timing protocol, or a second Doppler pre-compensation different than the first Doppler pre-compensation.

Clause 5: The method of Clause 4, wherein the second timing protocol or second first Doppler pre-compensation is based on a second location or second velocity information of the second non-terrestrial NE.

Clause 6: The method of any one of Clauses 1-5, wherein the first CC and the second CC are associated with a CA configuration in which the first CC is a primary CC and the second CC is a secondary CC.

Clause 7: The method of any one of Clauses 1-6, wherein communicating on the first CC further comprises performing control communication to configure the second CC for the second non-terrestrial NE.

Clause 8: The method of any one of Clauses 1-7, wherein the first frequency band is lower than the second frequency band.

Clause 9: The method of any one of Clauses 1-8, wherein the second frequency band comprises one of: an L band, an S band, a C band, an X band, a Ku band, a K band, or a Ka band.

Clause 10: The method of any one of Clauses 1-9, wherein the first frequency band is a terrestrial band and the second frequency band is a mobile satellite service band.

Clause 11: The method of any one of Clauses 1-10, wherein at least one of the first CC or the second CC is a downlink CC.

Clause 12: The method of any one of Clauses 1-11, wherein at least one of the first CC or the second CC is an uplink CC.

Clause 13: The method of any one of Clauses 1-12, wherein communicating the first non-terrestrial NE and communicating with the second non-terrestrial NE are based on a non-terrestrial network protocol.

Clause 14: The method of any one of Clauses 1-13, wherein the first non-terrestrial NE comprises a first satellite associated with a gateway and the second non-terrestrial NE comprises a second satellite associated with the gateway.

Clause 15: The method of any one of Clauses 1-14, wherein the first non-terrestrial NE comprises a first satellite associated with a first gateway and the second non-terrestrial NE comprises a second satellite associated with a second gateway.

Clause 16: The method of any one of Clauses 1-15, wherein the first non-terrestrial NE comprises a first regenerative satellite and the second non-terrestrial NE comprises a second regenerative satellite.

Clause 17: A method of wireless communication at a first non-terrestrial NE, comprising: establishing a first CC with a UE, wherein the first CC is in a first frequency band; and transmitting, to a second non-terrestrial NE, configuration information associated with a network-side CA configuration for the UE, the network-side CA configuration including a second CC between the second non-terrestrial NE and the UE in a second frequency band.

Clause 18: The method of Clause 17, wherein, in the network-side CA configuration, the first CC is a primary CC and the second CC is a secondary CC.

Clause 19: The method of any one of Clauses 17-18, wherein communicating on the first CC further comprises performing control communication to establish the second CC with the second non-terrestrial NE.

Clause 20: The method of any one of Clauses 17-19, wherein the first frequency band is lower than the second frequency band.

Clause 21: The method of any one of Clauses 17-20, wherein the second frequency band comprises one of: an L band, an S band, a C band, an X band, a Ku band, a K band, or a Ka band.

Clause 22: The method of Clause 21, wherein the first frequency band is a terrestrial band and the second frequency band is a mobile satellite service band.

Clause 23: The method of Clause 21, wherein at least one of the first CC or the second CC is a downlink CC.

Clause 24: The method of any one of Clauses 17-23, wherein at least one of the first CC or the second CC is an uplink CC.

Clause 25: The method of any one of Clauses 17-24, wherein the first CC is associated with a first timing protocol or a first Doppler pre-compensation.

Clause 26: The method of any one of Clauses 17-25, wherein the second CC is associated with a second timing protocol or a second Doppler pre-compensation.

Clause 27: The method of any one of Clauses 17-26, wherein the first non-terrestrial NE comprises a first satellite associated with a gateway and the second non-terrestrial NE comprises a second satellite associated with the gateway.

Clause 28: The method of any one of Clauses 17-27, wherein the first non-terrestrial NE comprises a first satellite associated with a first gateway and the second non-terrestrial NE comprises a second satellite associated with a second gateway.

Clause 29: The method of any one of Clauses 17-28, wherein the first non-terrestrial NE comprises a first regenerative satellite and the second non-terrestrial NE comprises a second regenerative satellite.

Clause 30: A method of wireless communication at a UE, comprising: registering with a first network system that is associated with a first core network architecture; and registering, while maintaining a first registration status with the first network system, with a second network system that is associated with a second core network architecture, wherein registering with the second network system is based on at least one of: a timer relative to a previous registration with the second network system, or location information relative to the previous registration.

Clause 31: The method of Clause 30, wherein the first network system is associated with a narrowband non-terrestrial network.

Clause 32: The method of Clause 31, wherein the second network system is associated with a non-terrestrial network.

Clause 33: The method of Clause 32, wherein the first core network architecture is an Evolved Packet Core architecture and the second core network architecture is a 5G Core architecture.

Clause 34: The method of Clause 32, wherein one of the first core network architecture or the second core network architecture comprises a service based architecture.

Clause 35: The method of any one of Clauses 30-34, wherein registering with the second network system further comprises registering with the second network system based on not having been registered with the second network system within a length of the timer.

Clause 36: The method of any one of Clauses 30-35, wherein registering with the second network system further comprises registering with the second network system based on not having been registered with the second network system in a tracking area indicated by the location information.

Clause 37: The method of any one of Clauses 30-36, further comprising monitoring for paging according to the first registration status and a second registration status associated with the second network system.

Clause 38: A method of wireless communication at a core network entity, comprising: identifying a first registration status of a UE with regard to a first network system having a core network architecture and a second registration status of the UE with regard to a second network system having a second core network architecture, wherein the second registration status is based on at least one of: a timer relative to a previous registration of the UE with a second network entity or the second core network architecture, or location information relative to the previous registration; and paging the UE on the first network system and the second network system in accordance with the first registration status and the second registration status.

Clause 39: The method of Clause 38, wherein the first network system is associated with a narrowband non-terrestrial network.

Clause 40: The method of Clause 39, wherein the second network system is associated with a non-terrestrial network.

Clause 41: The method of Clause 40, wherein the first core network architecture is an Evolved Packet Core architecture and the second core network architecture is a 5G Core architecture.

Clause 42: The method of any one of Clauses 38-41, wherein one of the first core network architecture or the second core network architecture comprises a service based architecture.

Clause 43: A method of wireless communication at a UE, comprising: establishing, in a terrestrial band, a connection with a non-terrestrial NE; and transmitting a communication, using Doppler pre-compensation, to the non-terrestrial NE via the connection, wherein the communication includes one or more muted tones based on the Doppler pre-compensation.

Clause 44: The method of Clause 43, wherein the one or more muted tones occur at a top edge of the terrestrial band based on the Doppler pre-compensation including a frequency increase for the communication.

Clause 45: The method of any one of Clauses 43-44, wherein the one or more muted tones occur at a bottom edge of the terrestrial band based on the Doppler pre-compensation including a frequency decrease for the communication.

Clause 46: The method of any one of Clauses 43-45, further comprising identifying the one or more muted tones based on the Doppler pre-compensation.

Clause 47: The method of any one of Clauses 43-46, further comprising receiving signaling indicating the one or more muted tones.

Clause 48: The method of any one of Clauses 43-47, wherein the one or more muted tones are based on a out-of-band emissions rule for the terrestrial band.

Clause 49: The method of any one of Clauses 43-48, wherein the NTN protocol is a New Radio NTN protocol.

Clause 50: The method of any one of Clauses 43-49, wherein communicating with the non-terrestrial NE via the connection comprises communicating using at least one of a timing protocol or the Doppler pre-compensation specific to the non-terrestrial NE in accordance with the NTN protocol.

Clause 51: A method for wireless communications by a UE comprising: communicating on a first CC with a first non-terrestrial NE, wherein the first CC is in a first frequency band; and communicating, while the first CC is active, on a second CC with a second non-terrestrial NE, wherein the second CC is in a second frequency band, wherein the first frequency band is a terrestrial band and the second frequency band is a mobile satellite service band.

Clause 52: The method of Clause 51, wherein the second frequency band comprises one of: an L band, an S band a C band, an X band a Ku band, a K band, or a Ka band.

Clause 53: The method of any one of Clauses 51-52, wherein communicating with the first non-terrestrial NE comprises applying at least one of: a first timing protocol, or a first Doppler pre-compensation.

Clause 54: The method of Clause 53, wherein the first timing protocol or the first Doppler pre-compensation is based on a first location or first velocity information of the first non-terrestrial NE.

Clause 55: The method of Clause 53, wherein communicating with the second non-terrestrial NE comprises applying at least one of: a second timing protocol different than the first timing protocol, or a second Doppler pre-compensation different than the first Doppler pre-compensation.

Clause 56: The method of Clause 55, wherein the second timing protocol or the second Doppler pre-compensation is based on a second location or second velocity information of the second non-terrestrial NE.

Clause 57: The method of any one of Clauses 51-56, wherein the first CC and the second CC are associated with a CA configuration in which the first CC is a primary CC and the second CC is a secondary CC.

Clause 58: The method of any one of Clauses 51-57, wherein communicating on the first CC comprises performing control communication to configure the second CC for the second non-terrestrial NE.

Clause 59: The method of any one of Clauses 51-58, wherein the first frequency band is lower than the second frequency band.

Clause 60: The method of any one of Clauses 51-59, wherein at least one of the first CC or the second CC is a downlink CC.

Clause 61: The method of any one of Clauses 51-60, wherein at least one of the first CC or the second CC is an uplink CC.

Clause 62: The method of any one of Clauses 51-61, wherein communicating with the first non-terrestrial NE and communicating with the second non-terrestrial NE are based on a non-terrestrial network protocol.

Clause 63: The method of any one of Clauses 51-62, wherein the first non-terrestrial NE comprises a first satellite associated with a gateway and the second non-terrestrial NE comprises a second satellite associated with the gateway.

Clause 64: The method of any one of Clauses 51-63, wherein the first non-terrestrial NE comprises a first satellite associated with a first gateway and the second non-terrestrial NE comprises a second satellite associated with a second gateway.

Clause 65: The method of any one of Clauses 51-64, wherein the first non-terrestrial NE comprises a first regenerative satellite and the second non-terrestrial NE comprises a second regenerative satellite.

Clause 66: The method of any one of Clauses 51-65, wherein the first non-terrestrial NE and the second non-terrestrial NE are a same non-terrestrial NE.

Clause 67: One or more apparatuses, comprising: one or more memories comprising executable instructions; and one or more processors configured to execute the executable instructions and cause the one or more apparatuses to perform a method in accordance with any one of Clauses 1-66.

Clause 68: One or more apparatuses configured for wireless communications, comprising: one or more memories; and one or more processors, coupled to the one or more memories, configured to cause the one or more apparatuses to perform a method in accordance with any one of Clauses 1-66.

Clause 69: One or more apparatuses configured for wireless communications, comprising: one or more memories; and one or more processors, coupled to the one or more memories, configured to perform a method in accordance with any one of Clauses 1-66.

Clause 70: One or more apparatuses, comprising means for performing a method in accordance with any one of Clauses 1-66.

Clause 71: One or more non-transitory computer-readable media comprising executable instructions that, when executed by one or more processors of one or more apparatuses, cause the one or more apparatuses to perform a method in accordance with any one of Clauses 1-66.

Clause 72: One or more computer program products embodied on one or more computer-readable storage media comprising code for performing a method in accordance with any one of Clauses 1-66.

Clause 73: One or more apparatuses configured for wireless communications, comprising: a processing system that includes one or more processors and one or more memories coupled with the one or more processors, the processing system configured to cause the one or more apparatuses to perform a method in accordance with any one of Clauses 1-66.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communication, comprising a processing system that includes one or more processors and one or more memories coupled with the one or more processors, the processing system configured to cause a user equipment (UE) to:
communicate on a first component carrier (CC) with a first non-terrestrial network entity (NE), wherein the first CC is in a first frequency band; and
communicate, while the first CC is active, on a second CC with a second non-terrestrial NE, wherein the second CC is in a second frequency band, wherein the first frequency band is a terrestrial band and the second frequency band is a mobile satellite service band.

2. The apparatus of claim 1, wherein the second frequency band comprises one of:
an L band,
an S band
a C band,
an X band
a Kᵤ band,
a K band, or
a Kₐ band.

3. The apparatus of claim 1, wherein to cause the UE to communicate with the first non-terrestrial NE, the processing system is configured to cause the UE to apply at least one of:
a first timing protocol, or
a first Doppler pre-compensation.

4. The apparatus of claim 3, wherein the first timing protocol or the first Doppler pre-compensation is based on a first location or first velocity information of the first non-terrestrial NE.

5. The apparatus of claim 3, wherein to cause the UE to communicate with the second non-terrestrial NE, the processing system is configured to cause the UE to apply at least one of:
a second timing protocol different than the first timing protocol, or
a second Doppler pre-compensation different than the first Doppler pre-compensation.

6. The apparatus of claim 1, wherein the first CC and the second CC are associated with a carrier aggregation (CA) configuration in which the first CC is a primary CC and the second CC is a secondary CC.

7. The apparatus of claim 1, wherein to cause the UE to communicate on the first CC, the processing system is configured to cause the UE to perform control communication to configure the second CC for the second non-terrestrial NE.

8. The apparatus of claim 1, wherein the first frequency band is lower than the second frequency band.

9. The apparatus of claim 1, wherein the first non-terrestrial NE and the second non-terrestrial NE are a same non-terrestrial NE.

10. An apparatus configured for wireless communication, comprising a processing system that includes one or more processors and one or more memories coupled with the one or more processors, the processing system configured to cause a user equipment (UE) to:
establish, in a terrestrial band, a connection with a non-terrestrial network entity (NE); and
transmit a communication, using Doppler pre-compensation, to the non-terrestrial NE via the connection, wherein the communication includes one or more muted tones based on the Doppler pre-compensation.

11. The apparatus of claim 10, wherein the one or more muted tones occur at a top edge of the terrestrial band based on the Doppler pre-compensation including a frequency increase for the communication.

12. The apparatus of claim 10, wherein the one or more muted tones occur at a bottom edge of the terrestrial band based on the Doppler pre-compensation including a frequency decrease for the communication.

13. The apparatus of claim 10, wherein the one or more processors are configured to further cause the apparatus to:
receive signaling indicative of the one or more muted tones.

14. The apparatus of claim 10, wherein the one or more muted tones are based on an out-of-band emissions rule for the terrestrial band.

15. The apparatus of claim 10, wherein to cause the UE to communicate with the non-terrestrial NE via the connection, the processing system is configured to cause the UE to communicate using at least one of a timing protocol or the Doppler pre-compensation specific to the non-terrestrial NE.

16. An apparatus configured for wireless communication, comprising a processing system that includes one or more processors and one or more memories coupled with the one or more processors, the processing system configured to cause a user equipment (UE) to:
register with a first network system that is associated with a first core network architecture; and
register, while maintaining a first registration status with the first network system, with a second network system that is associated with a second core network architecture, wherein registration with the second network system is based on at least one of a timer relative to a previous registration with the second network system or location information relative to the previous registration.

17. The apparatus of claim 16, wherein the first network system is associated with a narrowband non-terrestrial network.

18. The apparatus of claim 16, wherein to cause the UE to register with the second network system, the processing system is configured to cause the UE to register with the second network system based on not having been registered with the second network system within a length of the timer.

19. The apparatus of claim 16, wherein to cause the UE to register with the second network system, the processing system is configured to cause the UE to register with the second network system based on not having been registered with the second network system in a tracking area indicated by the location information.

20. The apparatus of claim 16, wherein the one or more processors are configured to further cause the apparatus to:
monitor for paging according to the first registration status and a second registration status associated with the second network system.
